(19) United States
(12) Patent Application Publication
(10) Pub. No.: US 2017/0205609 A1
(43) Pub. Date: Jul. 20, 2017

(54) IMAGE-FORMING OPTICAL SYSTEM, ILLUMINATION APPARATUS, AND MICROSCOPE APPARATUS

(71) Applicant: OLYMPUS CORPORATION, Tokyo (JP)

(72) Inventor: Hiroya FUKUYAMA, Tokyo (JP)

(73) Assignee: OLYMPUS CORPORATION, Tokyo (JP)

(21) Appl. No.: 15/477,226

(22) Filed: Apr. 3, 2017

Related U.S. Application Data
(63) Continuation of application No. PCT/JP2015/077973, filed on Oct. 1, 2015.

(30) Foreign Application Priority Data
Oct. 9, 2014 (JP) 2014-208113

(51) Int. Cl. G02B 21/00; G01N 21/64

(52) U.S. Cl. CPC G02B 21/006; G02B 21/0048; G02B 21/0032; G02B 21/0076; G01N 21/6458; G01N 2021/6463; G01N 2201/0697; G01N 2201/06113

(57) ABSTRACT

Provided is an image-forming optical system comprising: a plurality of image-forming lenses that form a final image and at least one intermediate image; a first phase modulator that is disposed further on an object side than any one of the intermediate images formed by the image-forming lenses is and that applies a spatial disturbance to a wavefront of light coming from the object; a second phase modulator that is disposed at a position at which at least one of the intermediate images is flanked by the first phase modulator and the second phase modulator, and that cancels out the spatial disturbance applied, by the first phase modulator, to the wavefront of the light coming from the object; and an adjusting part for adjusting an optical magnification in an image-forming relationship between the first and second phase modulators is included.

### CROSS-REFERENCE TO RELATED APPLICATIONS

This is a continuation of International Application PCT/JP2015/077973, with an international filing date of Oct. 1, 2015, which is hereby incorporated by reference herein in its entirety. This application claims the benefit of Japanese Patent Application No. 2014-208113, the content of which is incorporated herein by reference.

### TECHNICAL FIELD

The present invention relates to, for example, an image-forming optical system with which an image is formed by using laser light, and relates to an image-forming optical system, an illumination apparatus, and a microscope apparatus for enhancing image quality.

### BACKGROUND ART

In the related art, there are known methods in which a focal-point position in a subject object is moved in a direction along an optical axis (on Z-axis) by adjusting an optical-path length at an intermediate-image position (for example, see Patent Literatures 1 and 2).

### CITATION LIST

### Patent Literature

### {PTL 1} Publication of Japanese Patent No. 4011704

### {PTL 2} Japanese Translation of PCT International Application, Publication No. 2010-513968

### SUMMARY OF INVENTION

An aspect of the present invention is an image-forming optical system including a plurality of image-forming lenses that form a final image and at least one intermediate image; a first phase modulator that is disposed closer to an object than any one of the intermediate images formed by the image-forming lenses and that applies a spatial disturbance to a wavefront of light coming from the object; a second phase modulator that is disposed at a position that sandwiches at least one of the intermediate images with the first phase modulator and that cancels out the spatial disturbance applied to the wavefront of the light coming from the object by the first phase modulator, and an adjusting means for adjusting an optical magnification in an image-forming relationship between the first and second phase modulators.

Another aspect of the present invention is an illumination apparatus including: any one of the above-described image-forming optical systems and a light source that is disposed on an object side of the image-forming optical system and that generates illumination light to be made to enter the image-forming optical system.

Another aspect of the present invention is a microscope apparatus including any one of the above-described image-forming optical systems and a photo-detector that is disposed on a final-image side of the image-forming optical system and that detects light emitted from an observation subject.

With this aspect, with the photo-detector, it is possible to detect a sharp final image that is formed by preventing images of blemishes, foreign objects, defects, or the like on the surface of or inside the optical element from being superimposed on the intermediate image by using the image-forming optical system.

Another aspect of the present invention is a microscope apparatus including any one of the above-described image-forming optical systems; a light source that is disposed on an object side of the image-forming optical system and that generates illumination light to be made to enter the image-forming optical system; and a photo-detector that is disposed on a final-image side of the image-forming optical system and that detects light emitted from an observation subject.

Another aspect of the present invention is a microscope apparatus including the above-described illumination apparatus and a photo-detector that detects light emitted from an observation subject that is illuminated by the illumination apparatus, wherein the light source is a pulsed laser light source.

### BRIEF DESCRIPTION OF DRAWINGS

FIG. 1 is a schematic view showing an embodiment of an image-forming optical system employed in a microscope apparatus of the present invention.

FIG. 2 is a schematic view for explaining the operation of the image-forming optical system in FIG. 1.

FIG. 3 is an enlarged view showing portions between an object-side pupil position and a wavefront restoring device in FIG. 2.

FIG. 4 is a schematic view showing an image-forming optical system employed in a conventional microscope apparatus.

FIG. 5 is a schematic view showing an observation apparatus according to a first embodiment of the present invention.

FIG. 6 is a schematic view showing an observation apparatus according to a second embodiment of the present invention.

FIG. 7 is a schematic view showing an observation apparatus according to a third embodiment of the present invention.

FIG. 8 is a schematic view showing a modification of the observation apparatus in FIG. 7.

FIG. 9 is a schematic view showing a first modification of the observation apparatus in FIG. 8.

FIG. 10 is a magnified diagram showing the periphery of an optical-magnification adjusting portion in FIG. 9.

FIG. 11 is a schematic diagram showing an additional modification of the observation apparatus in FIG. 9.

FIG. 12 is a schematic view showing a second modification of the observation apparatus in FIG. 8.

FIG. 13 is a schematic view showing a third modification of the observation apparatus in FIG. 8.

FIG. 14 is a diagram showing a modification of the optical-magnification adjusting portion in FIG. 10.

FIG. 15 is a diagram showing another modification of the optical-magnification adjusting portion in FIG. 10.

FIG. 16 is a perspective view showing cylindrical lenses as examples of phase modulators used in the image-forming optical system and the observation apparatus of the present invention.

FIG. 17 is a schematic view for explaining the effects of employing the cylindrical lenses in FIG. 16.

FIG. 18 is a diagram for explaining the relationship between the phase modulation level and the optical power based on the Gaussian optics used for explaining FIG. 17.

FIG. 19 is a perspective view showing binary diffraction gratings as other examples of the phase modulators used in the image-forming optical system and the observation apparatus of the present invention.

FIG. 20 is a perspective view showing one-dimensional sine-wave diffraction gratings as other examples of the phase modulators used in the image-forming optical system and the observation apparatus of the present invention.

FIG. 21 is a perspective view showing free-curved surface lenses as other examples of the phase modulators used in the image-forming optical system and the observation apparatus of the present invention.

FIG. 22 is a longitudinal sectional view showing conical lenses as other examples of the phase modulators used in the image-forming optical system and the observation apparatus of the present invention.

FIG. 23 is a perspective view showing concentric binary diffraction gratings as other examples of the phase modulators used in the image-forming optical system and the observation apparatus of the present invention.

FIG. 24 is a schematic view for explaining the effects of a ray traveling along the optical axis when the diffraction gratings are used as the phase modulators.

FIG. 25 is a schematic view for explaining the effects of on-axis rays when the diffraction gratings are used as the phase modulators.

FIG. 26 is a diagram showing details of a center portion for explaining the effects of a diffraction grating that serves as a wavefront disturbing device.

FIG. 27 is a diagram showing the details of the center portion for explaining the effects of a diffraction grating that serves as a wavefront restoring device.

FIG. 28 is a longitudinal sectional view showing spherical aberration devices as other examples of the phase modulators used in the image-forming optical system and the observation apparatus of the present invention.

FIG. 29 is a longitudinal sectional view showing irregular-shaped devices as other examples of the phase modulators used in the image-forming optical system and the observation apparatus of the present invention.

FIG. 30 is a schematic view showing reflecting-type phase modulators as other examples of the phase modulators used in the image-forming optical system and the observation apparatus of the present invention.

FIG. 31 is a schematic view showing gradient-index devices as other examples of the phase modulators used in the image-forming optical system and the observation apparatus of the present invention.

FIG. 32 FIG. 32 is a diagram showing an example of a lens arrangement in the case in which the image-forming optical system of the present invention is applied to an apparatus for performing microscopically magnified observation in an endoscopic usage.

FIG. 33 is a diagram showing an example lens array for the case in which the image-forming optical system of the present invention is applied to a microscope provided with an endoscope-type small-diameter objective lens including an inner focusing function.

### DESCRIPTION OF EMBODIMENTS

An embodiment of an image-forming optical system 1 that is employed in a microscope apparatus of the present invention will be described below with reference to the drawings.

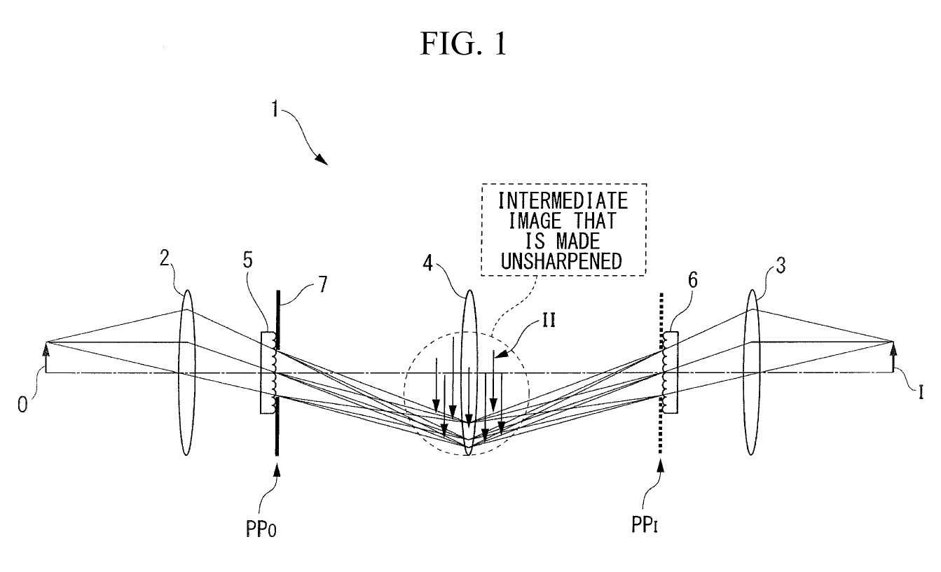

As shown in FIG. 1, the image-forming optical system 1 according to this embodiment is provided with two image-forming lenses 2 and 3 that are disposed as one set with a space therebetween; a field lens 4 that is disposed at an intermediate-image-forming plane between the image-forming lenses 2 and 3; a wavefront disturbing device (first phase modulator) 5 that is disposed in the vicinity of a pupil position PP_{O} of the image-forming lens 2 at the object O side; and a wavefront restoring device (second phase modulator) 6 that is disposed in the vicinity of a pupil position PP_{I} of the image-forming lens 3 at the image I side. Reference sign 7 in the figure indicates an aperture stop.

The wavefront disturbing device 5 is configured so as to disturb the wavefront when light that is emitted from an object O and that is focused by the image-forming lens 2 at the object O side passes therethrough. By disturbing the wavefront by means of the wavefront disturbing device 5, an intermediate image formed at the field lens 4 is made unsharp.

On the other hand, the wavefront restoring device 6 is configured so as to apply a phase modulation to light in such a way that the wavefront disturbance applied by the wavefront disturbing device 5 is cancelled out when light focused by the field lens 4 passes therethrough. The wavefront restoring device 6 possesses opposite phase properties relative to those of the wavefront disturbing device 5, so that a sharp final image I is formed by canceling out the wavefront disturbance.

More general concepts related to the image-forming optical system 1 according to this embodiment will now be described in detail.

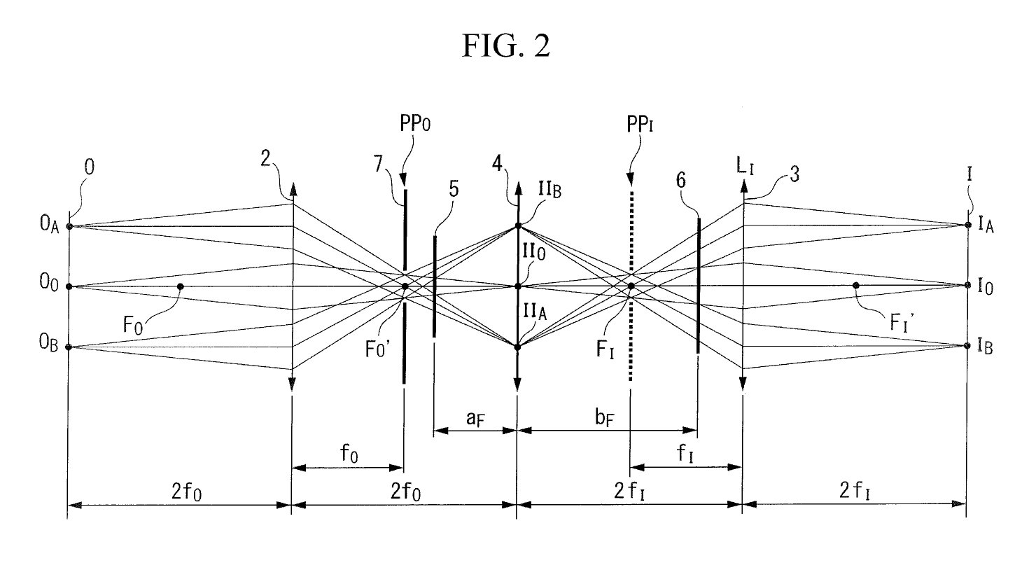

In the example shown in FIG. 2, the image-forming optical system 1 is telecentric on the object O side and the image I side. In addition, the wavefront disturbing device 5 is disposed at a position away from the field lens 4 by a distance a_{F} toward the object O, and the wavefront restoring device 6 is disposed at a position away from the field lens 4 by a distance b_{F} toward the image I.

In FIG. 2, reference sign f_{O} indicates the focal length of the image-forming lens 2, reference sign f_{I} indicates the focal length of the image-forming lens 3, reference signs F_{O} and F_{O}′ indicate focal positions of the image-forming lens 2, reference signs F_{I} and F_{I}′ indicate the focal positions of the image-forming lens 3, and reference signs II_{O}, II_{A}, and II_{g} indicate intermediate images.

Here, the wavefront disturbing device 5 need not necessarily be disposed in the vicinity of the pupil position PP_{O} of the image-forming lens 2, and, also, the wavefront restoring device 6 need not necessarily be disposed in the vicinity of the pupil position PP_{I} of the image-forming lens 3.

However, with regard to image formation by the field lens 4, the wavefront disturbing device 5 and the wavefront restoring device 6 must be disposed so as to have a mutually conjugate positional relationship, as indicated by Expression (1).

1/f_{F}=1/a_{F}+1/b_{F} (1)

where f_{F} is the focal length of the field lens 4.

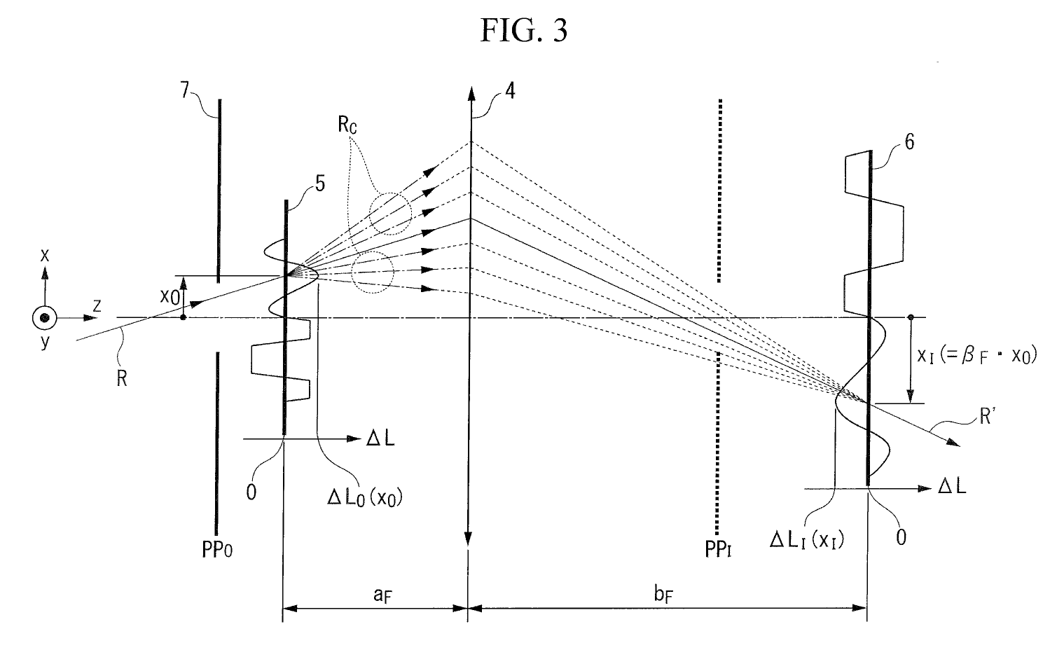

FIG. 3 is a diagram showing, in detail, the portion between the pupil position PP_{O} on the object O side and the wavefront restoring device 6 in FIG. 2.

Here, ΔL is a phase advance achieved, with reference to a ray that passes through a specific position (that is, a ray height), when light passes through an optical element.

In addition, ΔL_{O}(x_{O}) is a function that gives, with reference to the case in which light travels along an optical axis of wavefront disturbing device 5 (that is, x=0), a phase advance equal to that in the case in which light travels at an arbitrary ray height xₒ in the wavefront disturbing device 5.

Furthermore, ΔL_{I}(x_{I}) is a function that gives, with reference to the case in which light travels along an optical axis of the wavefront restoring device 6 (that is, x=0), a phase advance equal to that in the case in which light travels at an arbitrary ray height xᵢ in the wavefront restoring device 6.

ΔL_{O} (x_{O}) and ΔL_{I} (x_{I}) satisfy Expression (2) below.

ΔL_{O}(x_{O})+ΔL_{I}(x_{I})=ΔL_{O}(x_{O})+ΔL_{I}(β_{F}·x_{O})=0 (2)

Here, β_{F} is a lateral magnification of the field lens 4 when the wavefront disturbing device 5 and the wavefront restoring device 6 are in a conjugate relationship, which is expressed in Expression (3) below.

β_{F}=−b_{F}/a_{F} (3)

When a single ray R enters such an image-forming optical system 1 and passes through a position xₒ in the wavefront disturbing device 5, at that point, the ray is subjected to a phase modulation based on the function ΔL_{O}(x_{O}), and a disturbed ray R_{c} is generated due to refraction, diffraction, scattering, or the like. The disturbed ray R_{c} is projected by the field lens 4 to a position x_{I}=β_{F}·x_{O} on the wavefront restoring device 6, together with components of the ray R that were not subjected to the phase modulation. By passing therethrough, the projected ray is subjected to a phase modulation based on the function ΔL_{I}(β_{F}·x_{O})=−ΔL_{O}(x_{O}), and thus, the phase modulation applied thereto by the wavefront disturbing device 5 is cancelled out. By doing so, the ray is restored to a single ray R′ whose wavefront is not disturbed.

In the case in which the wavefront disturbing device 5 and the wavefront restoring device 6 are in a conjugate positional relationship and also possess the properties according to Expression (2), the ray that has been subjected to phase modulation by passing through a position in the wavefront disturbing device 5 passes through, without exception, a specific position in the wavefront restoring device 6, which is in one-to-one correspondence with the above-described position and at which the phase modulation that cancels out the phase modulation applied by the wavefront disturbing device 5 is applied. With the optical system shown in FIGS. 2 and 3, the above-described effects are exerted on the ray R regardless of the incident position x_{O} and the incident angle thereof in the wavefront disturbing device 5. Specifically, for all types of rays R, it is possible to make the intermediate image II unsharp and also to form a sharp final image I.

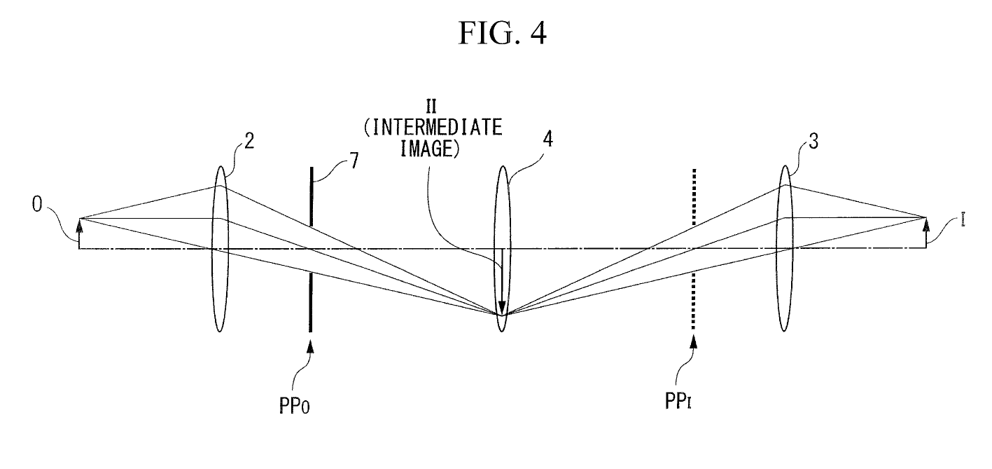

FIG. 4 shows a conventional image-forming optical system. With this image-forming optical system, light focused by the image-forming lens 2 at the object O side forms a sharp intermediate image II at the field lens 4 disposed at the intermediate-image-forming plane, and is subsequently focused by the image-forming lens 3 at the image I side, thus forming a sharp final image I.

With the conventional image-forming optical system, in the case in which there are blemishes, dust, or the like on a surface of the field lens 4 or there are defects, such as cavities or the like, inside the field lens 4, images of these foreign objects are superimposed on the sharp intermediate image formed at the field lens 4, which results in a problem in that the images of these foreign objects are also included when the final image I is formed.

In contrast, with the image-forming optical system 1 according to this embodiment, because an intermediate image II that has been made unsharp by the wavefront disturbing device 5 is formed at the intermediate-image-forming plane that is disposed at a position coinciding with the field lens 4, when the unsharp intermediate image II is made sharp by being subjected to the phase modulation by the wavefront restoring device 6, the images of foreign objects superimposed on the intermediate image II are made unsharp by being subjected to the same phase modulation. Therefore, it is possible to prevent the images of the foreign objects at the intermediate-image-forming plane from being superimposed on the sharp final image I.

Note that, in the above description, although the two image-forming lenses 2 and 3 have been described as being telecentrically disposed with respect to each other, their arrangement is not limited thereto, and similar effects are also achieved with a non-telecentric system.

In addition, although the function of the phase advance has been assumed to be a one-dimensional function, similar effects may also be achieved by employing a two-dimensional function instead.

In addition, spaces between the image-forming lens 2, the wavefront disturbing device 5, and the field lens 4 and spaces between the field lens 4, the wavefront restoring device 6, and the image-forming lens 3 need not necessarily be provided, and these devices may be optically coupled.

In addition, the individual lenses that form the image-forming optical system 1, namely, the image-forming lenses 2 and 3 and the field lens 4, are configured such that the image forming function and the pupil relay function are clearly divided therebetween; however, in an actual image-forming optical system, a configuration in which a single lens concurrently performs both the image forming function and the pupil relay function may also be employed. In such a case also, if the above-described conditions are satisfied, the wavefront disturbing device 5 can disturb the wavefront to make the intermediate image II unsharp, and the wavefront restoring device 6 can make the final image I sharp by canceling out the wavefront disturbance.

The image-forming optical system 1 according to this embodiment additionally includes an adjusting part for adjusting an optical magnification in the image-forming relationship between the wavefront disturbing device 5 and the wavefront restoring device 6. Configurations in which the image-forming optical system 1 includes the adjusting part will be described below in the form of image-forming optical systems 13, 32, and 42.

The image-forming optical system 13 and an observation apparatus (microscope apparatus) 10 according to a first embodiment of the present invention will be described below with reference to the drawings.

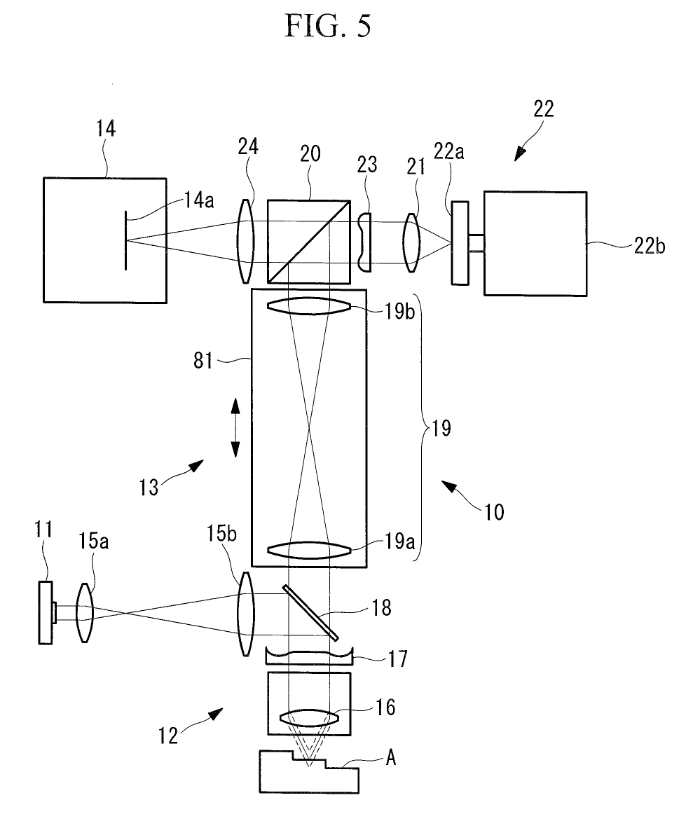

As shown in FIG. 5, the observation apparatus 10 according to this embodiment is provided with a light source 11 that generates non-coherent illumination light; an illumination optical system 12 that irradiates an observation subject A with the illumination light coming from the light source 11; an image-forming optical system 13 that focuses light coming from the observation subject A; and an image-acquisition device (photo-detector) 14 that captures the light focused by the image-forming optical system 13 and acquires an image thereof.

The illumination optical system 12 is provided with: focusing lenses 15a and 15b that focus the illumination light coming from the light source 11; and an objective lens 16 that irradiates the observation subject A with the illumination light focused by the focusing lenses 15a and 15b.

In addition, this illumination optical system 12 is a so-called Koehler illumination optical system, and the focusing lenses 15a and 15b are disposed so that a light emission surface of the light source 11 and a pupil plane of the objective lens 16 are conjugate with each other.

The image-forming optical system 13 is provided with the above-described objective lens (image-forming lens) 16 that is disposed on the object side and that collects observation light (for example, reflected light) emitted from the observation subject A; a wavefront disturbing device (first phase modulator) 17 that disturbs the wavefront of the observation light collected by the objective lens 16; a first beam splitter 18 that splits off the light whose wavefront has been disturbed from the illumination optical path from the light source 11; a first intermediate-image-forming-lens pair 19 that are disposed so as to have a space therebetween in the optical-axis direction; a second beam splitter 20 that deflects, by 90 between in the optical-axis directi individual lenses 19a and 19b of the first intermediate-image-forming-lens pair 19; a second intermediate-image-forming lens 21 that forms an intermediate image by focusing the light that has been deflected by the second beam splitter 20; an optical-path-length varying part 22 that is disposed at an intermediate-image-forming plane of the second intermediate-image-forming lens 21; a wavefront restoring device (second phase modulator) 23 that is disposed between the second beam splitter 20 and the second intermediate-image-forming lens 21; and an image-forming lens 24 that forms a final image by focusing the light that has passed through the wavefront restoring device 23 and the second beam splitter 20.

The image-acquisition device 14 is, for example, a two-dimensional image sensor, such as a CCD or a CMOS, is provided with an image-acquisition surface 14a disposed at a position at which a final image is formed by the image-forming lens 24, and is configured so that a two-dimensional image of the observation subject A can be acquired by capturing the incident light.

The wavefront disturbing device 17 is disposed in the vicinity of the pupil position of the objective lens 16. The wavefront disturbing device 17 is formed of an optically transparent material that allows light to pass therethrough, and is configured so that, when light passes therethrough, a phase modulation is applied to the wavefront of the light in accordance with depressions and protrusions on the surface of the optically transparent material. In this embodiment, the required wavefront disturbance is achieved by making the observation light coming from the observation subject A pass through the wavefront disturbing device 17 once.

In addition, the wavefront restoring device 23 is disposed in the vicinity of the pupil position of the second intermediate-image-forming lens 21. The wavefront restoring device 23 is also formed of an optically transparent material that allows light to pass therethrough, and is configured so as that, when light passes therethrough, a phase modulation is applied to the wavefront of the light in accordance with depressions and protrusions on the surface of the optically transparent material. In this embodiment, by making the observation light deflected by the beam splitter 20 and the observation light reflected by the optical-path-length varying part 22 so as to be folded back pass therethrough twice while the light travels in a reciprocating manner, the wavefront restoring device 23 is configured so as to apply, to the wavefront of the light, the phase modulation that cancels out the wavefront disturbance applied by the wavefront disturbing device 17.

The optical-path-length varying part 22 that serves as an optical axis (Z-axis) scanning system is provided with a flat mirror 22a that is disposed perpendicularly to the optical axis and an actuator 22b that displaces the flat mirror 22a in the optical-axis direction. When the flat mirror 22a is displaced in the optical-axis direction by actuating the actuator 22b of the optical-path-length varying part 22, the optical-path length between the second intermediate-image-forming lens 21 and the flat mirror 22a is changed, and, by doing so, the position in the observation subject A that is conjugate with the image-acquisition surface 14a, that is, the front focal-point position of the objective lens 16, is changed in the optical-axis direction.

In addition, as shown in FIG. 5, the image-forming optical system 13 is provided with an optical-magnification adjusting portion (adjusting part) 81 for adjusting the optical magnification in the image-forming relationship between the wavefront disturbing device 17 and the wavefront restoring device 23.

The optical-magnification adjusting portion 81 is configured so that the individual lenses 19a and 19b of the first intermediate image-forming-lens pair 19 can be moved in the optical-axis direction as a single unit. By moving the lenses 19a and 19b in the optical-axis direction as a single unit, it is possible to change the image-forming magnification of an image of the wavefront disturbing device 17 in the wavefront restoring device 23.

In order to observe the observation subject A by using the thus-configured observation apparatus 10 according to this embodiment, the illumination light coming from the light source 11 is radiated onto the observation subject A by means of the illumination optical system 12. The observation light emitted from the observation subject A is collected by the objective lens 16, passes through the first beam splitter 18 and the intermediate-image-forming optical system 19 by passing through the wavefront disturbing device 17 once, passes through the wavefront restoring device 23 by being deflected by 90 being the second beam splitter 20, passes through the wavefront restoring device 23 again by being reflected, so as to be folded back, by the flat mirror 22a of the optical-path-length varying part 22, and passes through the beam splitter 20, thus capturing a final image formed by the image-forming lens 24 by means of the image-acquisition device 14.

By moving the flat mirror 22a in the optical-axis direction by actuating the actuator 22b of the optical-path-length varying part 22, the optical-path length between the second intermediate-image-forming lens 21 and the flat mirror 22a can be changed, and, by doing so, the front focal-point position of the objective lens 16 can be moved in the optical-axis direction. Thus, by capturing the observation light at different focal-point positions, it is possible to acquire a plurality of images that are focused at different positions of the observation subject A in the depth direction. Furthermore, by applying high-frequency emphasizing processing after combining these images by taking an arithmetic average thereof, it is possible to acquire an image having a large depth of field.

In this case, although the intermediate image is formed by the second intermediate-image-forming lens 21 in the vicinity of the flat mirror 22a of the optical-path-length varying part 22, this intermediate image has been made unsharp due to wavefront disturbance that remains when the wavefront disturbance applied by passing through the wavefront disturbing device 17 is partially cancelled out by passing through the wavefront restoring device 23 once. Then, the light that has formed the unsharp intermediate image is focused by the second intermediate-image-forming lens 21 and is, subsequently, made to pass through the wavefront restoring device 23 again, which completely cancels out the wavefront disturbance thereof.

As a result, with the observation apparatus 10 according to this embodiment, there is an advantage in that, even if foreign objects such as blemishes, dust or the like exist on the surface of the flat mirror 22a, it is possible to prevent images of the foreign objects from being captured in a final image by being superimposed thereon, and that it is also possible to acquire a sharp image of the observation subject A.

Similarly, although the intermediate image formed by the first intermediate-image-forming-lens pair 19 also undergoes large changes in the optical-axis direction when the focal-point positions on the observation subject A are moved in the optical-axis direction, as a result of these changes, even if the intermediate image coincides with the position of the first intermediate-image-forming-lens pair 19, or even in the case in which another optical element additionally exits in the area in which the changes occur, because the intermediate image has been made unsharp, it is possible to prevent the images of the foreign objects from being captured in the final image by being superimposed thereon. In this embodiment, in the case in which a scanning system such as the one described above is included, no noise image is generated in any optical element disposed in the image-forming optical system, even if light is moved on the Z-axis.

Here, for example, in the case in which there are magnification errors due to manufacturing technologies in the first intermediate image-forming-lens pair (relay optical system) 19 that is formed of the lenses (relay lenses) 19a and 19b disposed in an intermediate space that includes the wavefront disturbing device 17 and the wavefront restoring device 23, and the magnification at which an image is formed by the first intermediate image-forming-lens pair 19 deviates from the design value, positions at which the wavefront disturbing device 17 and the wavefront restoring device 23 are conjugate with each other are not necessarily in such a relationship that phase modulations applied to light at the respective positions cancel each other (that is, the magnitudes thereof are equal to each other and the signs thereof are opposite). As a result, it is not possible to cancel out, by means of the wavefront restoring device 23, the spatial disturbance applied, by the wavefront disturbing device 17, to the wavefront of the observation light coming from the observation subject A, and thus, it is not possible to obtain a sharp image as the final image.

In this embodiment, by image-forming an image of the wavefront disturbing device 17 at a desired magnification in the wavefront restoring device 23 by moving the individual lenses 19a and 19b of the first intermediate image-forming-lens pair 19 in the optical-axis direction as a single unit by means of the optical-magnification adjusting portion 81, it is possible to make the positions at which phase modulations that are opposite to each other are applied to the wavefront of the light hold an optically conjugate relationship in the wavefront disturbing device 17 and the wavefront restoring device 23. By doing so, it is possible to completely eliminate blurriness components from the observation light that has passed through the wavefront restoring device 23, and thus, it is possible to obtain a sharp image of the observation subject A.

Next, an observation apparatus 30 according to a second embodiment of the present invention will be described below with reference to the drawings.

In describing this embodiment, the same reference signs are assigned to portions having the same configurations as those of the observation apparatus 10 according to the first embodiment described above, and descriptions thereof will be omitted.

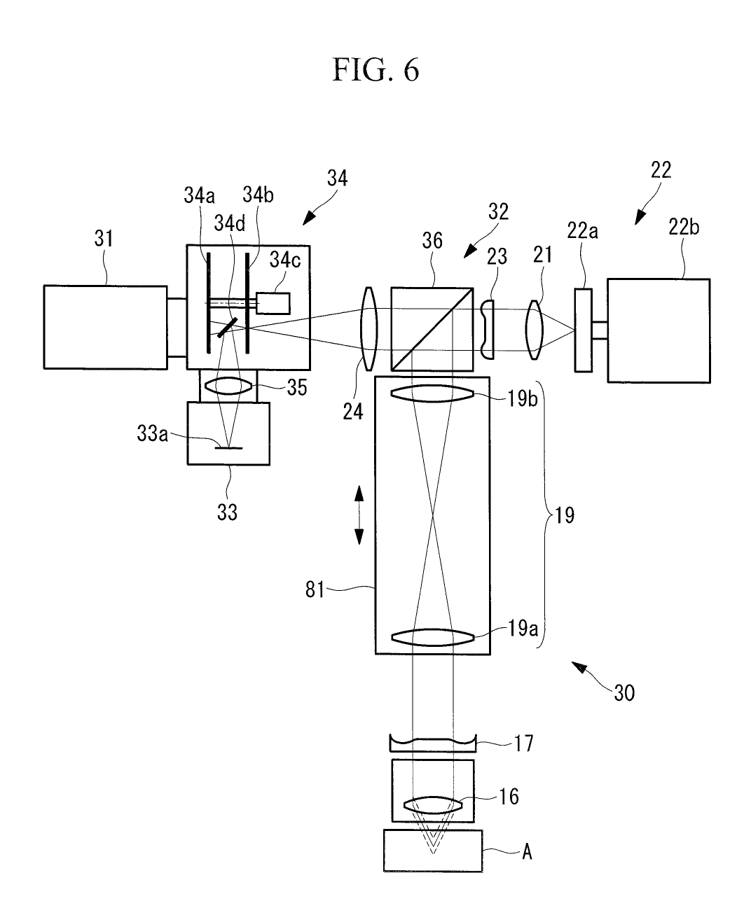

As shown in FIG. 6, an observation apparatus 30 according to this embodiment is provided with a laser light source 31; an image-forming optical system 32 that focuses laser beams coming from the laser light source 31 on the observation subject A and that also collects light coming from the observation subject A; an image-acquisition device (photo-detector) 33 that captures the light collected by the image-forming optical system 32; and a Nipkow-disk-type confocal optical system 34 that is disposed between the light source 31, and the image-acquisition device 33 and image-forming optical system 32. The laser light source 31, the image-forming optical system 32, and the Nipkow-disk-type confocal optical system 34 constitute an illumination apparatus.

The Nipkow-disk-type confocal optical system 34 is provided with two disks 34a and 34b that are disposed parallel to each other with a space therebetween and an actuator 34c that rotates the disks 34a and 34b at the same time. Numerous microlenses (not shown) are arrayed on the disk 34a on the laser light source 31 side, and the disk 34b on the object side is provided with numerous pinholes (not shown) at positions that correspond to the individual microlenses. In addition, a dichroic mirror 34d that splits light that has passed through the pinholes is secured in the space between the two disks 34a and 34b, and the light split off by the dichroic mirror 34d is focused by the focusing lens 35, a final image is formed on an image-acquisition surface 33a of the image-acquisition device 33, and thus, an image is acquired.

In the image-forming optical system 32, the first beam splitter 18 and the second beam splitter 20 in the first embodiment are unified into a single beam splitter 36, and thus, the optical path for irradiating the observation subject A with the light that has passed through the pinholes of the Nipkow-disk-type confocal optical system 34 and the optical path through which the light generated at the observation subject A enters the pinholes of the Nipkow-disk-type confocal optical system 34 are exactly the same.

The operation of the thus-configured observation apparatus 30 according to this embodiment will be described below.

With the observation apparatus 30 according to this embodiment, the light that enters the image-forming optical system 32 from the pinholes of the Nipkow-disk-type confocal optical system 34 is focused by the second intermediate-image-forming lens 21 after passing through the beam splitter 36 and the phase modulator (second phase modulator) 23, and is reflected by the flat mirror 22a of the optical-path-length varying part 22 so as to be folded back. Then, after passing through the second intermediate-image-forming lens 21, the light passes through the phase modulator 23 again, is deflected by 90gain, the beam splitter 36, passes through the first intermediate-image-forming-lens pair 19 and the phase modulator (first phase modulator) 17, and is focused on the observation subject A by the objective lens 16.

In this embodiment, the phase modulator 23 through which the laser beam passes twice first serves as a wavefront disturbing device that disturbs the wavefront of the laser beam, and the phase modulator 17 through which the laser beam subsequently passes once serves as a wavefront restoring device that applies the phase modulation that cancels out the wavefront disturbance applied by the phase modulator 23.

Therefore, although an image of the light sources that are formed like numerous point sources of light by the Nipkow-disk-type confocal optical system 34 is formed as an intermediate image on the flat mirror 22a by the second intermediate-image-forming lens 21, because the intermediate image formed by the second intermediate-image-forming lens 21 is made unsharp by passing through the phase modulator 23 once, it is possible to prevent a problem by the images of the foreign objects existing in the intermediate-image-forming plane are superimposed on the final image.

In addition, because the disturbance applied to the wavefront by passing through the phase modulator 23 twice is canceled out by passing through the phase modulator 17 once, it is possible to form a sharp image of the numerous point sources of light at the observation subject A. Then, high-speed scanning can be performed by moving the image of the numerous point sources of light formed at the observation subject A in the XY-direction that intersects the optical axis by rotating the disks 34a and 34b by actuating the actuator 34c of the Nipkow-disk-type confocal optical system 34.

On the other hand, light, for example, fluorescence, generated at the position in the observation subject A at which the image of the point sources of light is formed is collected by the objective lens 16, is deflected by 90 is the beam splitter 36 after passing through the phase modulator 17 and the first intermediate-image-forming-lens pair 19, passes through the phase modulator 23, is focused by the second intermediate-image-forming lens 21, and is reflected by the flat mirror 22a so as to be folded back. Subsequently, the light is focused by the second intermediate-image-forming lens 21 again, passes through the phase modulator 23 and the beam splitter 36, is focused by the image-forming lens 24, and forms an image at the pinhole position of the Nipkow-disk-type confocal optical system 34.

The light that has passed through the pinholes is split off from the optical path from the laser light source by the dichroic mirror, is focused by the focusing lens, and forms the final image at the image-acquisition surface of the image-acquisition device.

In this case, the phase modulator 17 through which the fluorescence generated at the observation subject in the form of numerous points passes serves as a wavefront disturbing device as in the first embodiment, and the phase modulator 23 serves as a wavefront restoring device.

Therefore, by passing through phase modulator 23 once, although the fluorescence whose wavefront has been disturbed by passing through the phase modulator 17 would be in a state in which the disturbance is partially cancelled out, the intermediate image formed on the flat mirror 22a would be an unsharp image. Then, the fluorescence whose wavefront disturbance has completely been cancelled out by passing through the phase modulator 23 once more forms an image at the pinholes of the Nipkow-disk-type confocal optical system 34, is split by the dichroic mirror 34d after passing through the pinholes, is focused by the focusing lens 35, and forms a sharp final image on the image-acquisition surface 33a of the image-acquisition device 33.

By doing so, with the observation apparatus according to this embodiment, there is an advantage in that, as an illumination apparatus that radiates laser beams onto the observation subject A and also as an observation apparatus with which fluorescence generated at the observation subject A is captured, it is possible to acquire a sharp final image while preventing images of foreign objects at an intermediate-image-forming plane from being superimposed on the final image by making the intermediate image unsharp. In this embodiment, in the case in which a scanning system such as the one described above is included, no noise image is generated in any optical element disposed in the image-forming optical system, even if light is moved on the Z-axis.

Next, an observation apparatus 40 according to a third embodiment of the present invention will be described below with reference to the drawings.

In describing this embodiment, the same reference signs are assigned to portions having the same configurations as those of the observation apparatus 30 according to the second embodiment described above, and descriptions thereof will be omitted.

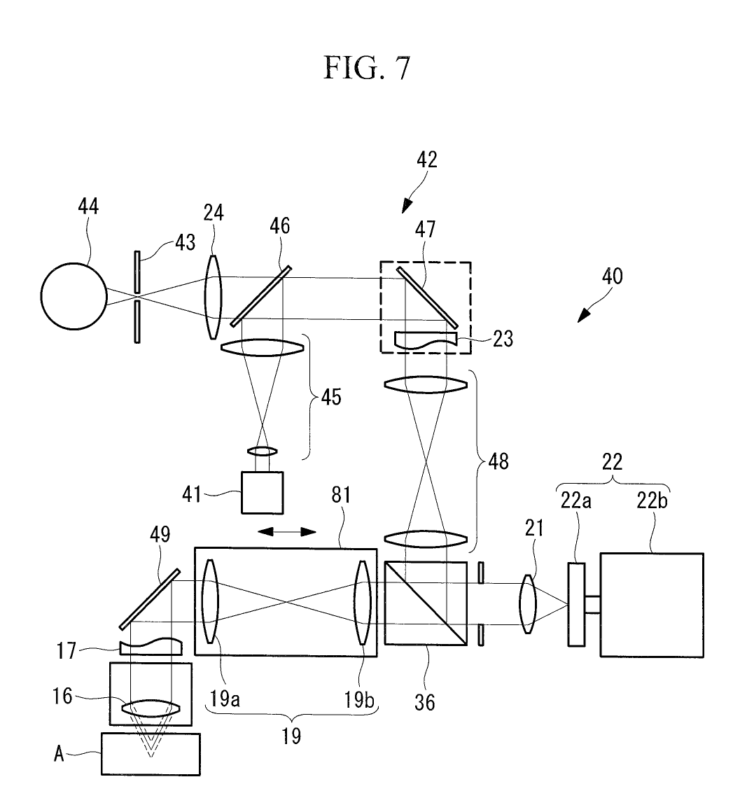

As shown in FIG. 7, the observation apparatus 40 according to this embodiment is a laser-scanning confocal observation apparatus.

This observation apparatus 40 is provided with a laser light source 41; an image-forming optical system 42 that focuses laser beams coming from the laser light source 41 on the observation subject A and that also collects light coming from the observation subject A; a confocal pinhole 43 that allows fluorescence collected by the image-forming optical system 42 to pass therethrough; and a photo-detector 44 that detects the fluorescence that has passed through the confocal pinhole 43. The laser light source 41 and the image-forming optical system 42 constitute an illumination apparatus.

As components differing from those of the observation apparatus 30 according to the second embodiment, the image-forming optical system 42 is provided with a beam expander 45 that expands the beam diameter of a laser beam, a dichroic mirror 46 that deflects the laser beam and that allows fluorescence to pass therethrough, a galvanometer mirror 47 that is disposed in the vicinity of a position that is conjugate with the pupil of the objective lens 16, and a third intermediate-image-forming-lens pair 48. In addition, the phase modulator 23 that disturbs the wavefront of the laser beam is disposed in the vicinity of the galvanometer mirror 47. In the figures, reference sign 49 indicates a mirror.

The operation of the thus-configured observation apparatus 40 according to this embodiment will be described below.

With the observation apparatus 40 according to this embodiment, the laser beam emitted from the laser light source 41, whose diameter is expanded by the beam expander 45, is deflected by the dichroic mirror 46, and is two-dimensionally scanned by the galvanometer mirror 47, after which the laser beam passes through the phase modulator 23 and the third intermediate-image-forming-lens pair 48, and enters the beam splitter 36.

Although the laser light that has entered the beam splitter 36 forms intermediate images by being incident on the flat mirror 22a of the optical-path-length varying part 22, a disturbance has been applied, by the phase modulator 23, to the wavefront thereof prior to this, which unsharpens the intermediate images, and thus it is possible to prevent images of foreign objects that exist at the intermediate image-forming plane from being superimposed thereon. In addition, because the wavefront disturbance is cancelled out by the phase modulator 17 disposed at the pupil position of the objective lens 16, it is possible to form a sharp final image at the observation subject A. In addition, the image formation depth of the final image can be arbitrarily adjusted by the optical-path-length varying part 22.

On the other hand, fluorescence generated at a position in the observation subject A at which the laser beam forms the final image is collected by the objective lens 16, travels along the optical path in the reverse route from that traveled by the laser beam after passing through the phase modulator 17, is deflected by the beam splitter 36, passes through the third intermediate-image-forming-lens pair 48, the phase modulator 23, the galvanometer mirror 47, and the dichroic mirror 46, and is focused at a confocal pinhole 43 by the image-forming lens 24; and thus, only the fluorescence that has passed through the confocal pinhole 43 is detected by the photo-detector 44.

In this case also, because the fluorescence collected by the objective lens 16 forms an intermediate image after the wavefront thereof is disturbed by the phase modulator 17, the intermediate image is made unsharp, and thus, it is possible to prevent the images of foreign objects that exist in the intermediate-image-forming plane from being superimposed thereon. Also, because the wavefront disturbance is cancelled out by passing through the phase modulator 23, it is possible to form a sharp image at the confocal pinhole 43, and it is possible to efficiently detect the fluorescence generated at the position in the observation subject A at which the laser beam forms the final image. As a result, there is an advantage in that it is possible to acquire a high-resolution, bright confocal image. In this embodiment, in the case in which a scanning system such as the one described above is included, no noise image is generated in any optical element disposed in the image-forming optical system, even if light is moved on the Z-axis.

As with the first and second embodiments, this embodiment is configured so that the individual lenses 19a and 19b of the first intermediate image-forming-lens pair 19 are moved in the optical-axis direction as a single unit by means of the optical-magnification adjusting portion 81. Alternatively, for example, lenses 48a and 48b may be moved in the optical-axis direction as a single unit by providing the optical-magnification adjusting portion 81 at the third intermediate image-forming-lens pair 48, or the optical-magnification adjusting portions 81 may be provided at both the set of lenses in the first intermediate image-forming-lens pair 19 and the set of lenses in the third intermediate image-forming-lens pair 48, and both sets of lenses may be individually moved in the optical-axis direction as a single unit.

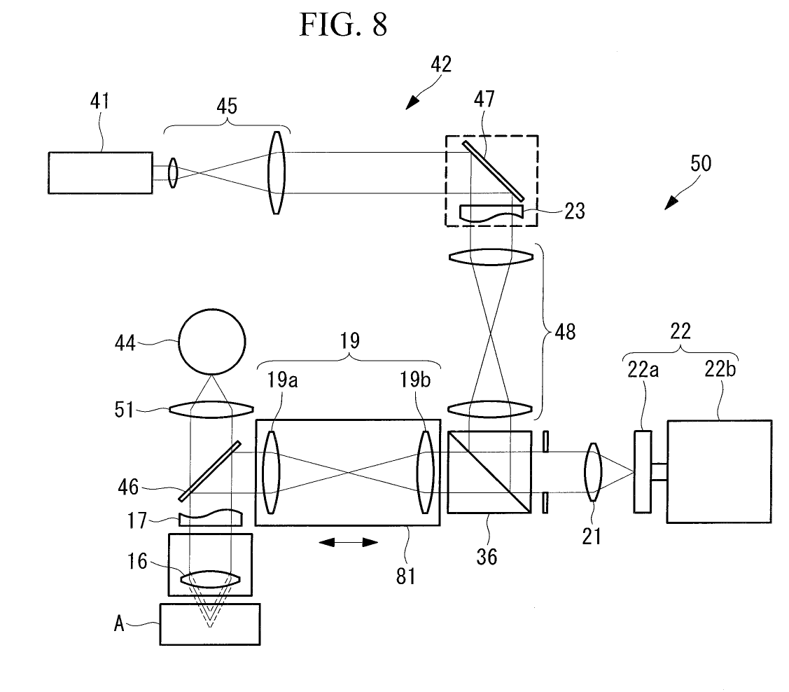

Note that, in this embodiment, although a laser-scanning confocal observation apparatus has been described as an example, alternatively, the present invention may be applied to a laser-scanning multi-photon-excitation observation apparatus, as shown in FIG. 8.

In this case, an ultrashort pulsed laser light source may be employed as the laser light source 41, the dichroic mirror 46 may be eliminated from the original position, and the dichroic mirror 46 may be employed instead of the mirror 49.

With an observation apparatus 50 in FIG. 8, it is possible to make the final image sharp by making the intermediate image unsharp by using its function as an illumination apparatus that radiates an ultrashort pulsed laser beam onto the observation subject A. With regard to the fluorescence generated at the observation subject A, the fluorescence is collected by the objective lens 16, passes through the phase modulator 17 and the dichroic mirror 46, is subsequently focused by the focusing lens 51 without forming an intermediate image, and is directly detected by the photo-detector 44.

In this modification also, the individual lenses 19a and 19b of the first intermediate image-forming-lens pair 19 may be moved along the optical-axis direction as a single unit by means of the optical-magnification adjusting portion 81, or both the set of lenses in the first intermediate image-forming-lens pair 19 and the set of lenses in the third intermediate image-forming-lens pair 48 may be individually moved in the optical-axis direction.

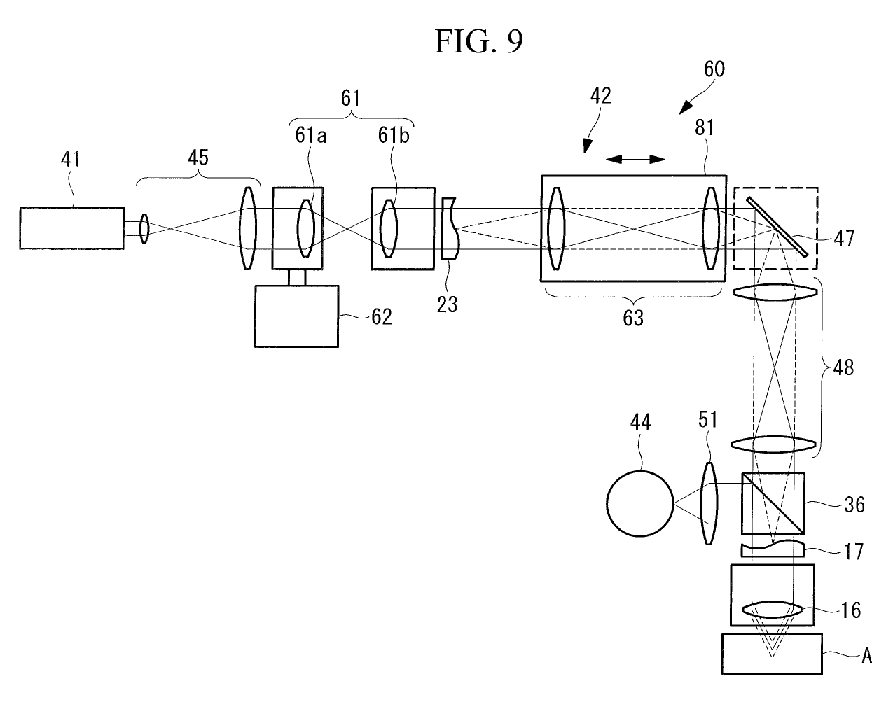

In addition, in the individual embodiments described above, by means of the optical-path-length varying part 22 that changes the optical-path length via the movement of the flat mirror that folds back the optical path, the front focal-point position of the objective lens is changed in the optical-axis direction. Alternatively, an observation apparatus 60 may be configured by employing, as the optical-path-length varying part, a unit that changes the optical-path length by moving a lens 61a, which is one of lenses 61a and 61b that form an intermediate-image-forming optical system 61, in the optical-axis direction by using the actuator 62, as shown in FIG. 9. In the figures, reference sign 63 indicates another intermediate-image-forming optical system. In addition, in FIG. 9, beams represented by solid lines indicate object image-forming, and beams represented by broken lines indicate pupil image-forming.

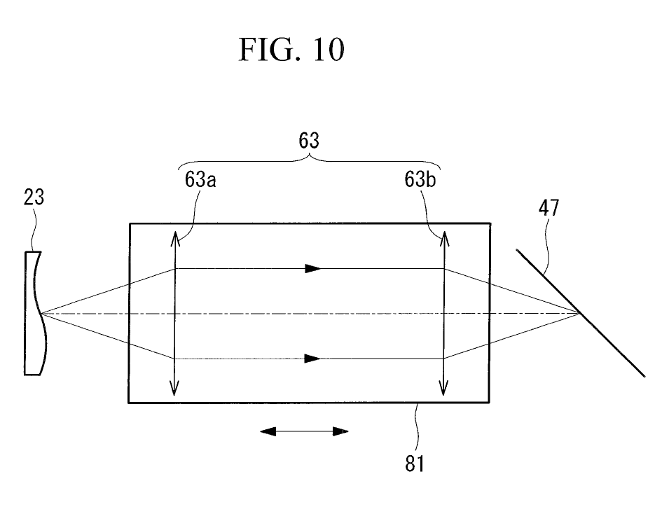

As shown in FIG. 10, this modification is provided with the optical-magnification adjusting portion (adjusting part) 81 that adjusts the optical magnification in the image-forming relationship between the phase modulator 17 and the phase modulator 23.

The optical-magnification adjusting portion 81 is configured so that individual lenses 63a and 63b of another intermediate image-forming optical system 63 can be moved along the optical-axis direction as a single unit.

As shown in FIG. 9, when the individual lenses 63a and 63b are moved, as a single unit, toward the phase modulator 17 by means of the optical-magnification adjusting portion 81, the size of an image of the phase modulator 23 at the galvanometer mirror 47, which is conjugate with the phase modulator 23, is further reduced. In addition, because the galvanometer mirror 47 is conjugate with the phase modulator 17 via individual lenses 48a and 48b of the third intermediate image-forming-lens pair 48, the size of the image of the phase modulator 23 at the phase modulator 17 is finally reduced. In other words, the image-forming magnification βpm of the phase modulator 23 at the phase modulator 17 is reduced.

On the other hand, when the individual lenses 63a and 63b are moved, as a single unit, toward the phase modulator 23 by means of the optical-magnification adjusting portion 81, the size of an image of the phase modulator 23 at the phase modulator 17 is increased. In other words, the image-forming magnification βpm of the phase modulator 23 at the phase modulator 17 is increased.

Therefore, even in the case in which there are magnification errors or the like due to manufacturing technologies in the individual lenses 63a and 63b of another intermediate image-forming optical system 63, by moving the individual lenses 63a and 63b in the optical-axis direction as a single unit by means of the optical-magnification adjusting portion 81, it is possible to form an image of the phase modulator 23 at an accurate, desired magnification with respect to the phase modulator 17. By doing so, a relationship in which the phase modulations applied by the phase modulator 23 and the phase modulator 17 completely cancel each other is formed, thus completely removing the blurriness components from the beam that has passed through the phase modulator 17, which makes it possible to radiate spot illumination of ultra-short pulsed-laser light without blurriness onto the observation subject A, and thus, it is possible to finally obtain a sharp image of the observation subject A.

Note that, in some cases, the focal-point positions, that is, positions at the galvanometer mirror 47 and the phase modulator 17 at which images of the phase modulator 23 is formed, are sometimes moved in the optical-axis direction in association with movement of the individual lenses 63a and 63b as a single unit. With regard to this phenomenon, in the case in which the image-forming magnification βpm between the phase modulators is 1 or a value that is close to 1, such movements are not problematic because the movements of the positions at which images of the phase modulator 23 are formed are extremely small. In addition, in the case in which the image-forming magnification βpm between the phase modulators greatly differs from 1, that is, in the case of magnified projection or reduced projection, because the movements of the positions at which images of the phase modulator 23 are formed are increased, a method of eliminating focal-point displacements should be employed, as described later.

In addition, in this modification also, for example, the individual lenses 48a and 48b may be moved in the optical-axis direction as a single unit by providing the optical-magnification adjusting portion 81 at the third intermediate image-forming-lens pair 48, or the optical-magnification adjusting portions 81 may be provided at both the set of lenses in another intermediate image-forming optical system 63 and the set of lenses in the third intermediate image-forming-lens pair 48, and both sets of lenses may be individually moved in the optical-axis direction as a single unit.

In addition, as shown in FIG. 11, another intermediate image-forming optical system 80 is disposed between two galvanometer mirrors 47 that constitute a two-dimensional light scanner, and the two galvanometer mirrors 47 are precisely disposed in an optically conjugate positional relationship relative to the phase modulators 17 and 23 and an aperture stop 81 disposed at the pupil of the objective lens 16.

In this case, the optical-magnification adjusting portion 81 may be provided at any one of the set of lenses in another intermediate image-forming optical system 63, the set of lenses in another intermediate image-forming optical system 80, and the set of lenses in the third intermediate image-forming-lens pair 48, and that set of lenses may be moved in the optical-axis direction as a single unit, or arbitrary multiple sets of lenses among these may be individually moved in the optical-axis direction as a single unit.

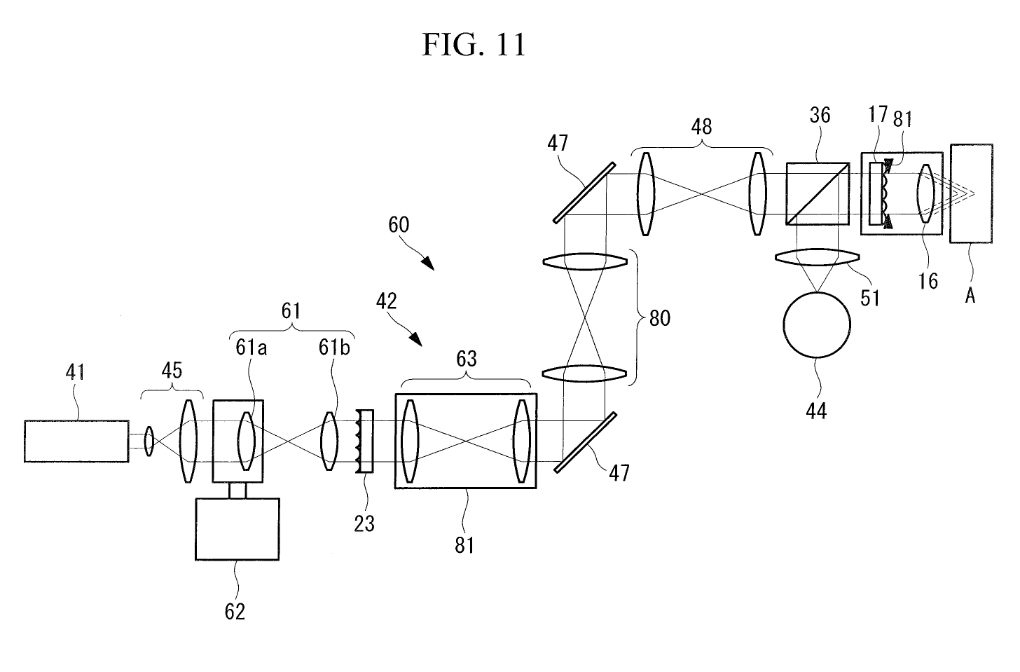

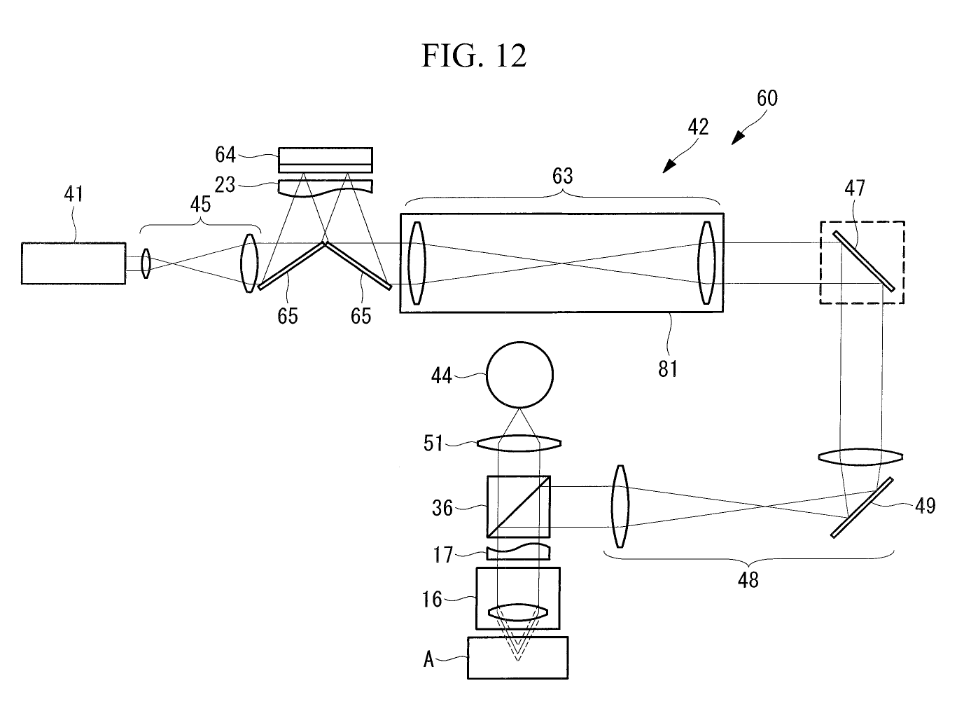

In addition, a spatial light modulator (SLM) 64, such as a reflecting-type LCOS, may be employed as the optical-path-length varying part, as shown in FIG. 12. By doing so, it is possible to change the front focal-point position of the objective lens 16 in the optical-axis direction at high speed by changing the phase modulation to be applied to the wavefront at high speed by controlling liquid crystals of the LCOS. In the figures, reference sign 65 indicates a mirror.

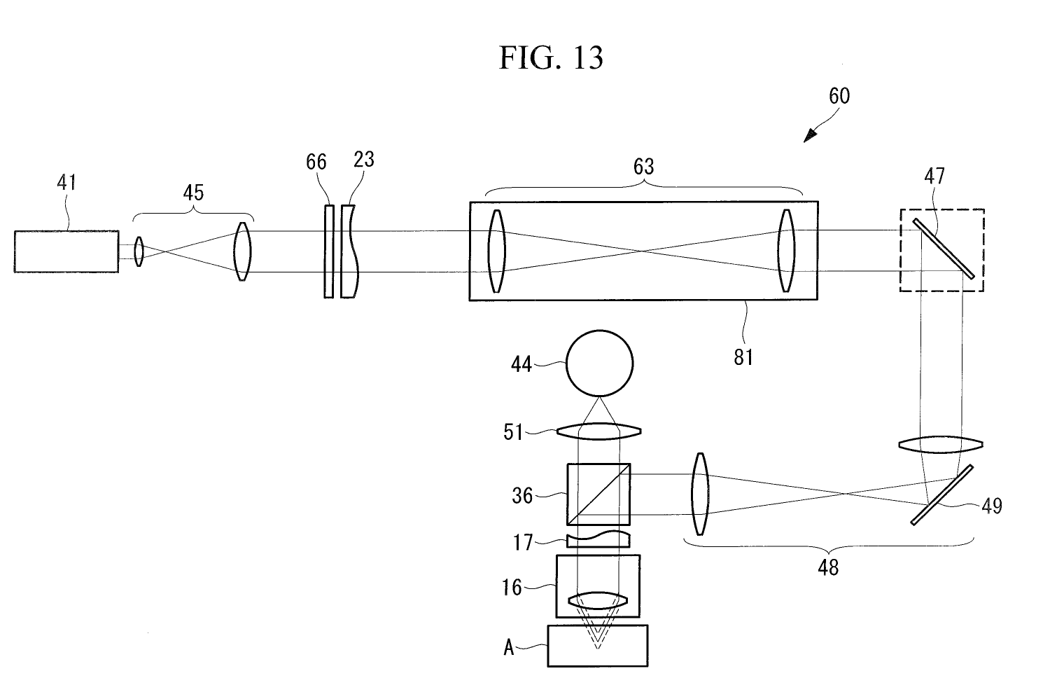

In addition, instead of the spatial light modulator 64 such as a reflecting-type LCOS, a spatial light modulator 66 such as a transmitting-type LCOS may be employed, as shown in FIG. 13. Because the mirror 65 can be eliminated, as compared with the case in which the reflecting-type LCOS is employed, the configuration can be simplified.

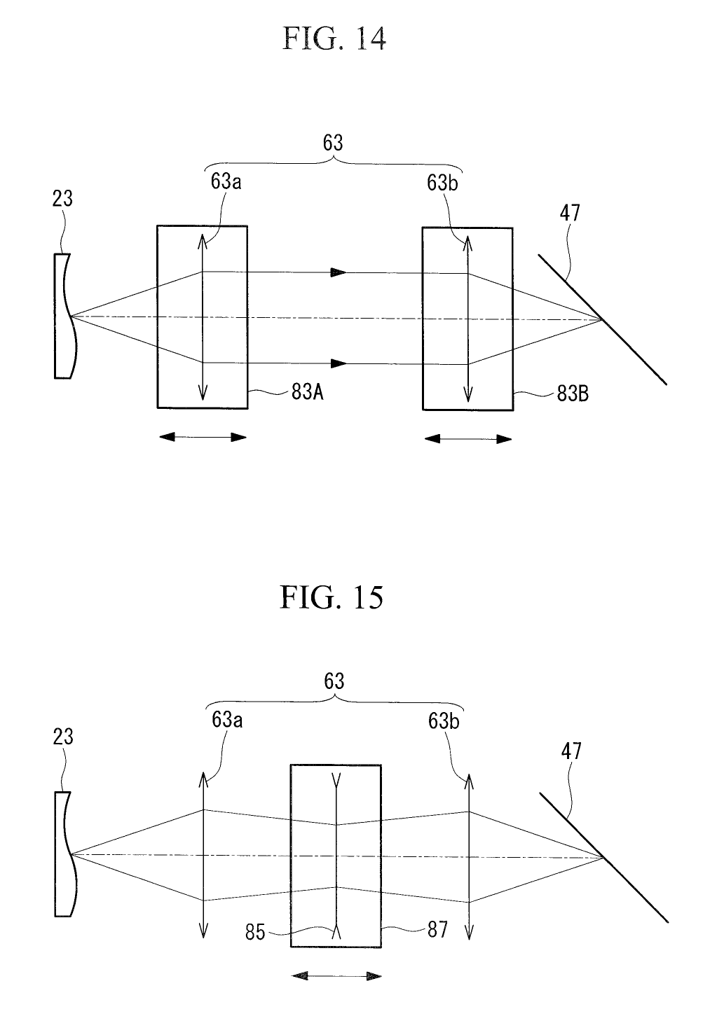

In the individual embodiments described above, although the optical-magnification adjusting portion 81, which moves, as a single unit, the individual lenses that constitute the intermediate image-forming-lens pair 19, 48, 63, or 80, has been described as an example of the adjusting part, as an optical-magnification adjusting portion, it would be even better if, not only were it possible to adjust the optical magnification in the image-forming relationship between the phase modulator 17 and the phase modulator 23, but also were it possible to eliminate focal-point displacements caused in association with the magnification adjustment, that is, displacements of the positions at which images of the phase modulators are formed. For example, optical-magnification adjusting portions 83A and 83B that separately move, in the optical-axis direction, the individual lenses in the intermediate image-forming-lens pair 19, 48, 63, or 80 may be employed. FIG. 14 shows an example of a configuration in which the optical-magnification adjusting portion 83A separately moves the lens 63a, which is one of the lenses in another intermediate image-forming optical system 63, and the optical-magnification adjusting portion 83B separately moves the lens 63b, which is the other lens in the optical-axis direction.

In FIG. 14, when the individual lenses 63a and 63b are individually moved toward the phase modulator 17 by means of the optical-magnification adjusting portions 83A and 83B, the image-forming magnification βpm of the phase modulator 23 at the phase modulator 17 is reduced, and, when the individual lenses 63a and 63b are individually moved toward the phase modulator 23, the image-forming magnification βpm of the phase modulator 23 at the phase modulator 17 is increased.

In this case, by setting an appropriate difference between the amounts by which the lenses 63a and 63b are moved by the optical-magnification adjusting portions 83A and 83B, it is possible to eliminate the movements of the focal-point positions, that is, the focal-point displacements of the phase modulators, that are caused when the individual lenses 63a and 63b are moved as a single unit.

Therefore, with this modification, it is possible to adjust the image-forming magnifications of the phase modulators while suppressing the movements of the focal-point positions.

In addition, as shown in FIG. 15, in the individual embodiments described above, a single concave lens 85 that can be moved in the optical-axis direction may be disposed in the optical path between the lenses 63a and 63b of another intermediate image-forming optical system 63, and an optical-magnification adjusting portion 87 that moves the concave lens 85 in the optical-axis direction may be employed. With regard to moving the concave lens 85 in the optical-axis direction by means of the optical-magnification adjusting portion 87, it is possible to form a so-called optically-compensated zoom lens by configuring another intermediate image-forming optical system 63 as a zoom lens.

In this case, when the concave lens 85 is moved toward the phase modulator 17, the image-forming magnification βpm of the phase modulator 23 at the phase modulator 17 is increased, and, when the concave lens 85 is moved toward the phase modulator 23, the image-forming magnification βpm of the phase modulator 23 at the phase modulator 17 is reduced.

In this modification, even if the focal-point positions are moved in association with changes in the image-forming magnification, this is not problematic because the amount of movement involved is extremely small.

In addition, in this modification, at least one of the lenses 63a and 63b may be configured so as to be movable in the optical-axis direction. By moving one of or both of the lenses 63a and 63b in the optical-axis direction, it is possible to cancel out the movements of the focal-point positions caused by the movements of the concave lens 85.

In addition, in this modification, a cam (not shown) that links the movements of the concave lens 85 in the optical-axis direction and the movements of at least one of the lenses 63a and 63b in the optical-axis direction may be employed, and a so-called mechanically-compensating zoom lens may be formed by using the lenses 63a and 63b, the concave lens 85, and the cam.

As a means of moving the focal-point position in the observation subject A in the optical-axis direction other than the individual examples that have been described (the optical-path-length varying part 22, or the intermediate-image-forming optical system 61 and the actuator 62, or a reflecting-type spatial light modulator 64, or the transmitting-type spatial light modulator 66), it is possible to use various types of variable-power optical elements, which are known as active optical elements, including, first of all, as ones that have mechanically movable portions, a variable-shape mirror (DFM: Deformable Mirror) and a variable-shape lens employing liquid or gel. Also, examples of similar devices that do not have mechanically movable portions include, among others, a liquid-crystal lens and a potassium tantalate niobate (KTN: KTa₁₋ₓNbₓO₃) crystal lens that control the refractive index of a medium by means of an electric field, and, additionally, a lens in which a cylindrical-lens effect in an acoustic optical deflector (AOD/Acousto-Optical Deflector) is applied.

As has been described above, in the embodiments of the present invention in the form of microscopes, some means of moving the focal-point position in the observation subject A in the optical-axis direction is included in all cases. Furthermore, with these means of moving the focal-point position in the optical-axis direction, as compared with means employed in a conventional microscope designed for the same purpose (namely, to move either the objective lens or the observation subject in the optical-axis direction), it is possible to considerably increase the operating speed because a low-mass object to be driven is used or a physical phenomenon whose response speed is high is utilized.

This affords an advantage in that it is possible to detect phenomena occurring at higher speed in an observation subject (for example, living biological tissue specimen).

In addition, in the case in which the spatial light modulators 64 and 66, such as a transmitting-type or a reflecting-type LCOS, are employed, it is possible to make the spatial light modulators 64 and 66 perform the function of the phase modulator 23. By doing so, it is possible to omit the phase modulator 23 that serves as a wavefront disturbing device, and thus, there is an advantage in that it is possible to simplify the configuration.

In addition, although the above-described example is a form in which the phase modulator 23 is omitted in a combination of the spatial light modulator and a laser-scanning multi-photon-excitation observation apparatus, in a similar manner, it is also possible to omit the phase modulator 23 in a combination of the spatial light modulator and a laser-scanning confocal observation apparatus. Specifically, in FIGS. 12 and 13, the mirror 49 can be employed instead of the dichroic prism 36, the dichroic mirror 46 can be employed between the beam expander 45 and the spatial light modulators 64 and 66, thus forming a branch optical path; and, furthermore, given that the image-forming lens 24, the confocal pinhole 43, and the photo-detector 44 are employed, it is possible to make the spatial light modulators 64 and 66 perform the function of the phase modulator 23. The spatial light modulators 64 and 66 in this case serve as wavefront disturbing devices with respect to a laser beam coming from the laser light source 41, disturbing the wavefront thereof, and, on the other hand, serve as wavefront restoring devices with respect to fluorescence coming from the observation subject A, canceling out the wavefront disturbance applied thereto by the phase modulator 17.

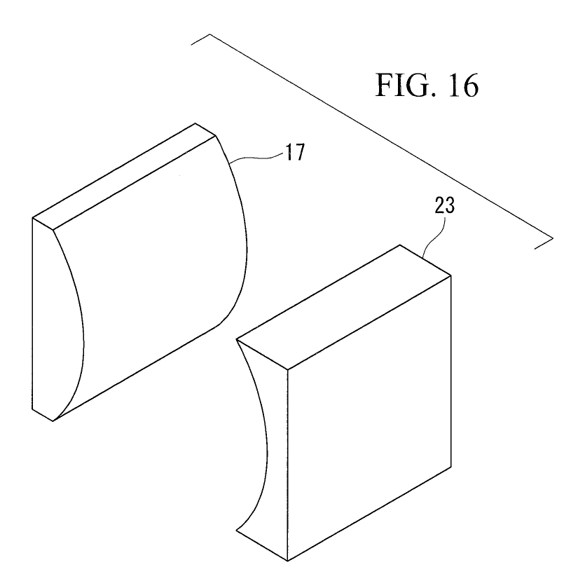

As shown in FIG. 16, cylindrical lenses 17 and 23 may be employed as phase modulators, for example.

In this case, with the cylindrical lens 17, because an intermediate image in the form of a point image is elongated into a linear shape due to astigmatism, it is possible to make the intermediate image unsharp by means of this effect, and it is possible to make the final image sharp by means of the cylindrical lens 23 having a shape that is complementary thereto.

In the case shown in FIG. 16, either a convex lens or a concave lens may be used as a wavefront disturbing device or may be used as a wavefront restoring device.

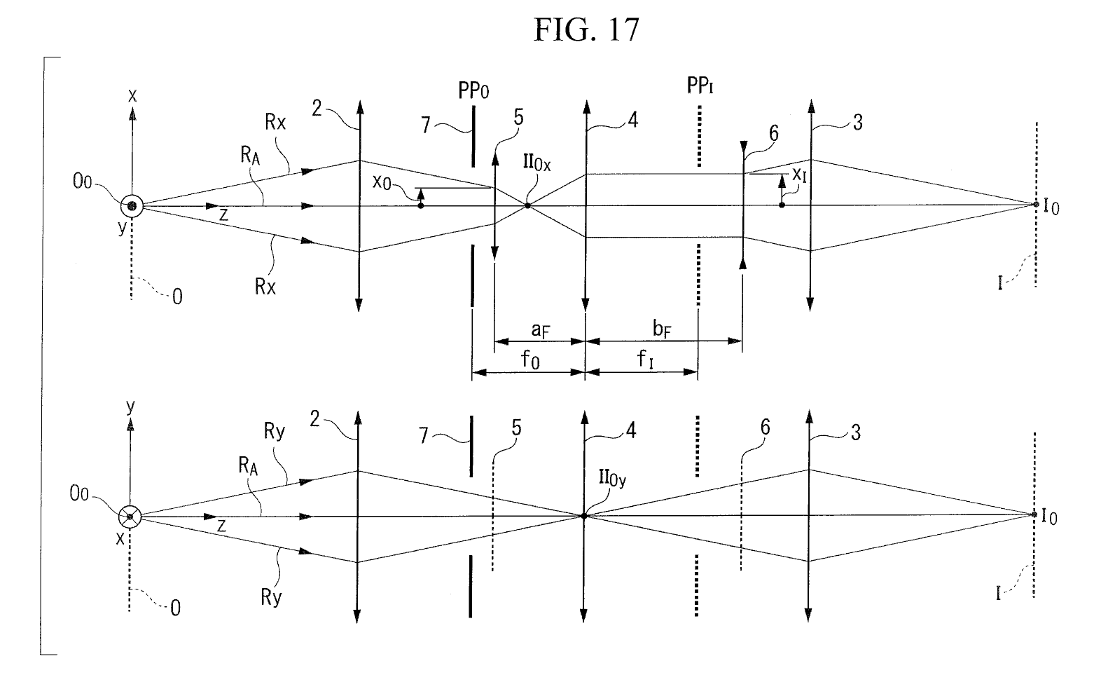

The effect of using cylindrical lenses 5 and 6 as the phase modulators will be described below in detail. FIG. 17 shows an example in which the cylindrical lenses 5 and 6 are used as the phase modulators in FIGS. 2 and 3.

Here, the following conditions are set in particular.

(a) A cylindrical lens having a power ψ_{Ox} in the X-direction is used as the object-O-side phase modulator (wavefront disturbing device) 5.
(b) A cylindrical lens having a power ψ_{Ix} in the X-direction is used as the image-I-side phase modulator (wavefront restoring device) 6.
(c) A position (ray height) of an on-axis ray R_{X} on the X-Z plane in the cylindrical lens 5 is assumed to be xₒ.
(d) A position (ray height) of an on-axis ray Rₓ on the X-Z plane in the cylindrical lens 6 is assumed to be x_{I}.

In FIG. 17, reference signs II_{OX} and II_{OY} indicate intermediate images.

Before describing the effects of this example, the relationship between the phase modulation level and the optical power based on Gaussian optics will be described by using FIG. 18.

In FIG. 18, assuming that the lens thickness at the height (distance from the optical axis) x is d(x) and that the lens thickness at the height 0 (on the optical axis) is dₒ, the optical-path length L(x) between the entrance-side tangential plane and the exit-side tangential plane extending along a ray at the height x is expressed by Expression (4) below.

L(x)=(d_{O}−d(x))+n·d(x) (4)

The difference between the optical-path length L(x) at the height x and the optical-path length L(0) at the height 0 (on the optical axis) is expressed by Expression (5) below, when the thin-lens approximation is used.

L(x)−L(0)=(−x²/2)(n−1)(1/r₁−1/r₂) (5)

Regarding the optical-path-length difference L(x)−L(0) described above, the absolute value thereof is equal to the phase advance of light exiting at the height x relative to an exit at the height 0, and the sign thereof is reversed. Therefore, the above-described phase advance is expressed by Expression (6) below, which has an opposite sign to Expression (5).

L(0)−L(x)=(x²/2)(n−1)(1/r₁−1/r₂) (6)

On the other hand, the optical power ψ of this thin lens is expressed by Expression (7) below.

Ψ=1/f=(n−1)(1/r₁−1/r₂) (7)

Therefore, based on Expressions (6) and (7), the relationship between the phase advance L(0)−L(x) and the optical power φ is determined by Expression (8) below.

L(0)−L(x)=φ·x²/2 (8)

Here, let us return to describing FIG. 17.

The phase advance ng_{Oc} experienced by the on-axis ray Rₓ on the X-Z plane in the cylindrical lens 5 relative to an on-axis principal ray, that is, a ray R_{A} traveling along the optical axis, is expressed by Expression (9) below based on Expression (8).

ΔL_{OC}(x_{O})=L_{Oc}(0)−L_{Oc}(x_{O})=ψ_{Ox}·X_{O}²/2 (9)

Here, L_{OC}(x_{O}) is a function of the optical-path length between the entrance-side tangential plane and the exit-side tangential plane, extending along a ray at the height x_{O} in the cylindrical lens 5.

Similarly, the phase advance ly_{Ic} experienced by the on-axis ray Rₓ on the X-Z plane in the cylindrical lens 6 relative to the on-axis principal ray, that is, the ray R_{A} traveling along the optical axis, is expressed by Expression (10) below.

ΔL_{Ic}(x_{I})=L_{Ic}(0)−L_{Ic}(x_{I})=ψ_{Ix}·x_{I}²/2 (10)

Here, L_{Ic}(x_{I}) is a function of the optical-path length between the entrance-side tangential plane and the exit-side tangential plane, extending along a ray at the height x_{I} in the cylindrical lens 6.

When the relationships expressed in Expressions (9) and (10) and (x_{I}/x_{O})²=β_{F}² are applied to the above-described Expression (2), in this example, conditions for the cylindrical lens 5 to perform the function of disturbing a wavefront and those for the cylindrical lens 6 to perform the function of restoring a wavefront are determined as indicated by Expression (11).

ψ_{Ox}/ψ_{Ix}=−v_{F}² (11)

Specifically, it is necessary that the values of ψ_{Ox} and ψ_{Ix} have signs that are opposite from each other, and, also, that the ratio of their absolute values is proportional to the square of the lateral magnification of the field lens 4.

Note that, although the above descriptions are based on the on-axis ray, so long as the above-described conditions are satisfied, the cylindrical lenses 5 and 6 also perform the functions of disturbing a wavefront and restoring a wavefront in a similar manner for an off-axis ray.

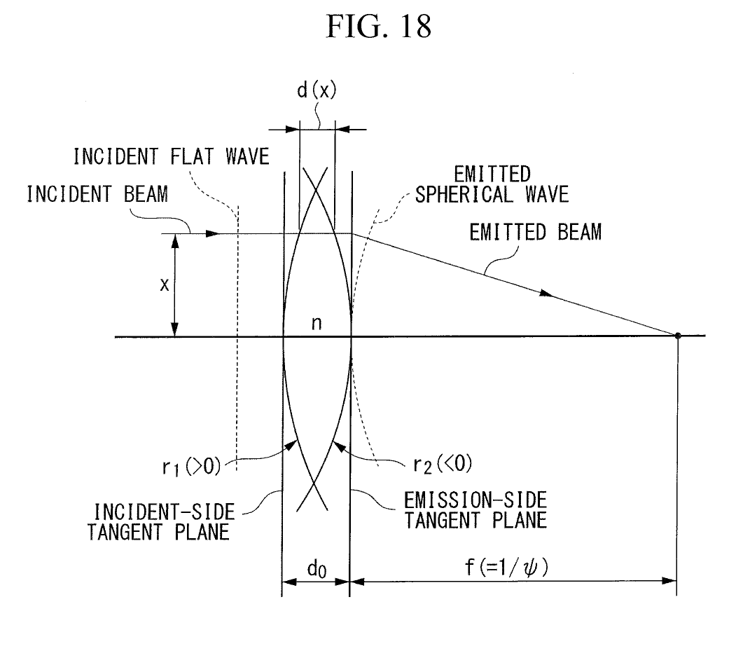

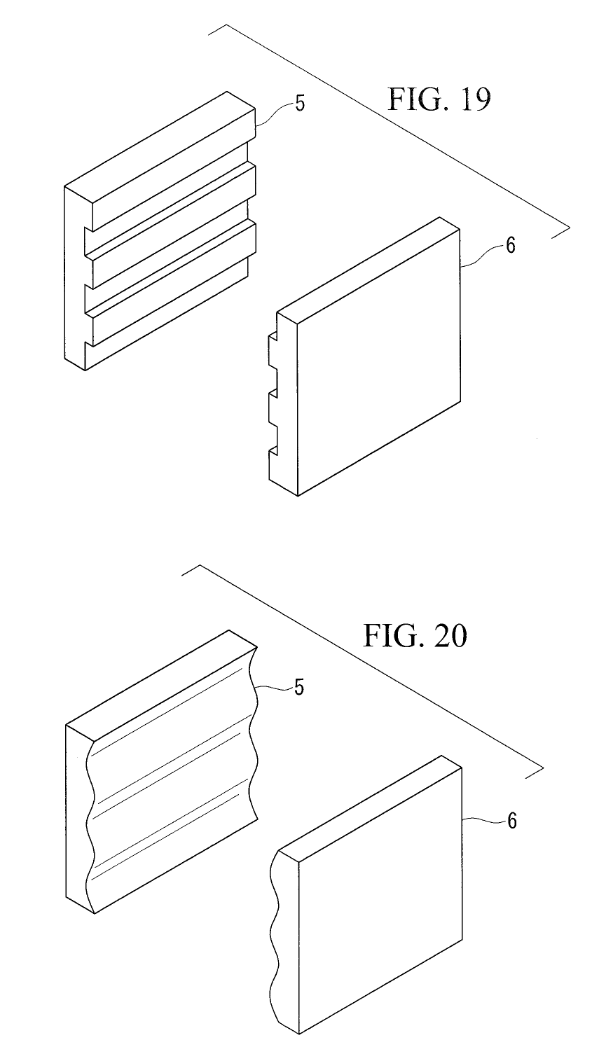

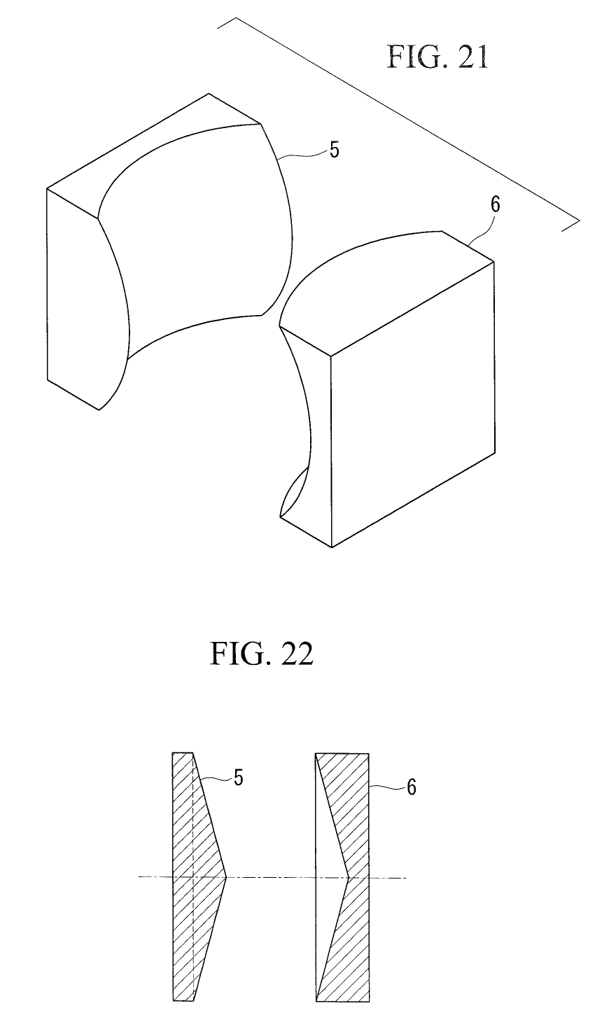

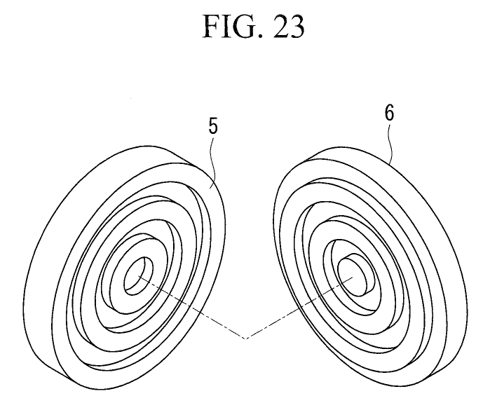

In addition, as the phase modulators 5, 6, 17, and 23 (displayed in figures as the phase modulators 5 and 6), one-dimensional binary diffraction gratings shown in FIG. 19, one-dimensional sine-wave diffraction gratings shown in FIG. 20, free-curved surface lenses shown in FIG. 21, conical lenses shown in FIG. 22, or concentric binary diffraction gratings shown in FIG. 23 may be employed instead of cylindrical lenses. The concentric diffraction gratings are not limited to the binary type, and an arbitrary form, such as the blazed type, the sine-wave type, or the like, can be employed.

Here, the case in which the diffraction gratings 5 and 6 are employed as wavefront modulating devices will be described below in detail.

In an intermediate image II in this case, a single point image is separated into a plurality of point images by diffraction.

Due to this effect, the intermediate image II is made unsharp, and thus, it is possible to prevent images of foreign objects in the intermediate-image-forming plane from appearing in the final image by being superimposed thereon.

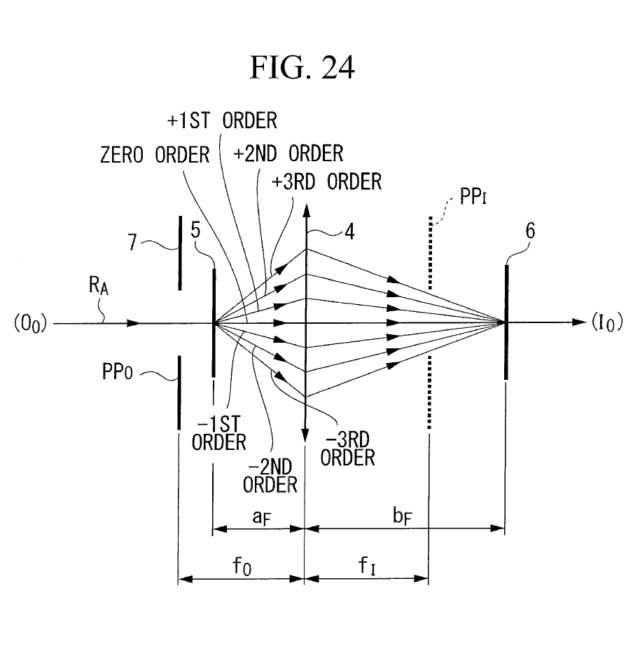

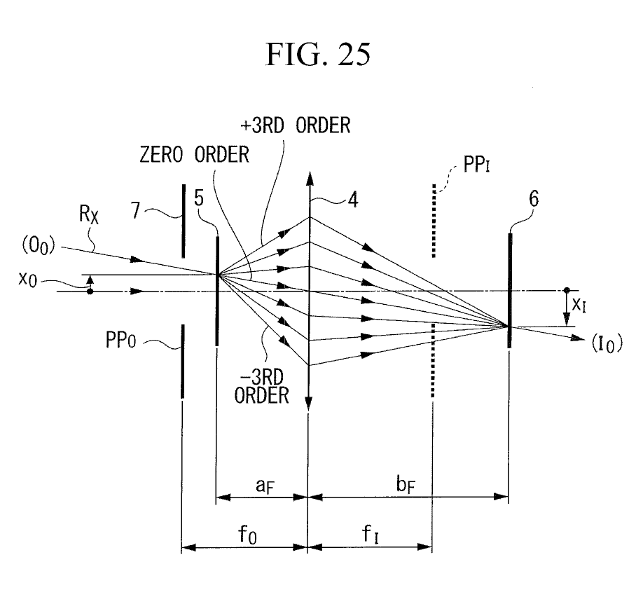

For the case in which the diffraction gratings 5 and 6 are employed as phase modulators, an example of a preferable route for an on-axis principal ray, that is, the ray R_{A} traveling along the optical axis, is shown in FIG. 24, and, in addition, an example of a preferable route for the on-axis ray R_{X} is shown in FIG. 25. In these figures, although the rays R_{A} and R_{X} are separated into a plurality of diffracted rays via the diffraction grating 5, they are restored into a single ray, as was originally the case, by passing through the diffraction grating 6.

In this case also, by satisfying the above-described Expressions (1) to (3), it is possible to achieve the above-described effects.

Here, following FIGS. 24 and 25, it is possible to describe Expression (2) in a different manner such that “the sum of phase modulations the diffraction gratings 5 and 6 apply to a single on-axis ray R_{X} is always equal to the sum of phase modulations the diffraction gratings 5 and 6 apply to the on-axis principal ray R_{A}”.

In addition, in the case in which the diffraction gratings 5 and 6 have periodic structures, if the shapes (that is, phase modulation properties) thereof satisfy Expression (2) in a region corresponding to one period, it is possible to assume that Expression (2) is similarly satisfied in other regions.

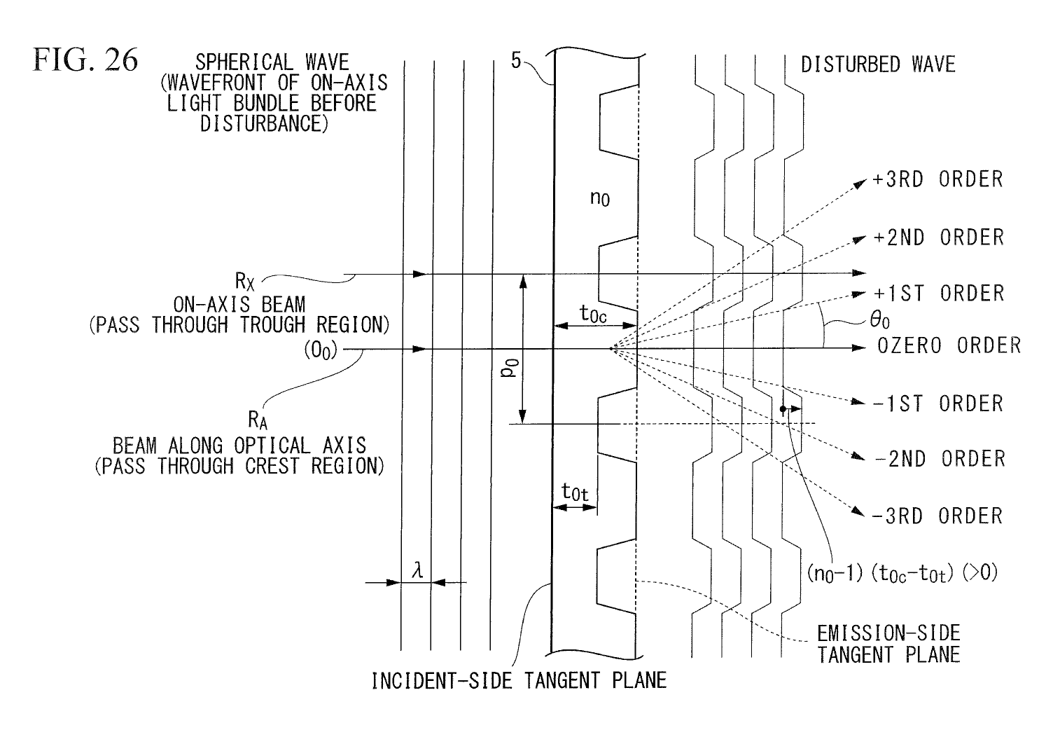

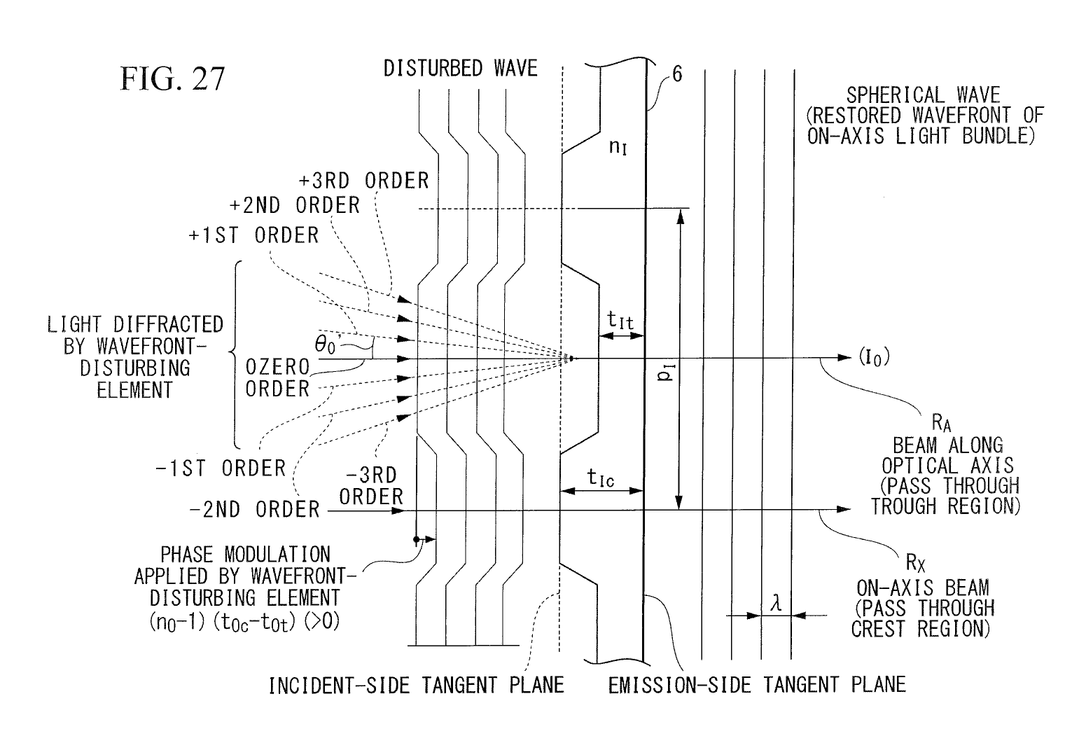

Therefore, center portions of the diffraction gratings 5 and 6, that is, regions in the vicinity of the optical axis, will be focused on in the following description. FIG. 26 is a diagram showing details of the center portion of the diffraction grating 5, and FIG. 27 is a diagram showing details of the center portion of the diffraction grating 6.

Here, the following descriptions are the conditions for the diffraction gratings 5 and 6 to satisfy Expression (2).

Specifically, a modulation period p_{I} of the diffraction grating 6 must be equal to a modulation period pₒ of the diffraction grating 5 projected by the field lens 4; a modulation phase of the diffraction grating 6 must be reversed with respect to a modulation phase of the diffraction grating 5 projected by the field lens 4; and, also, the magnitude of the phase modulation by the diffraction grating 5 and the magnitude of the phase modulation by the diffraction grating 6 must be equal to each other in terms of absolute values.

First, the conditions for the period p_{I} and the projected period pₒ to be equal to each other are expressed by Expression (12).

p_{I}=|β_{F}|·pₒ (12)

Next, in order for the modulation phase of the diffraction grating 6 to be reversed with respect to the projected modulation phase of the diffraction grating 5, in addition to satisfying the above-described Expression (12), for example, the diffraction grating 5 needs to be disposed so that one of the centers of protruding regions thereof is aligned with the optical axis and also the diffraction grating 6 needs to be disposed so that one of the centers of depressed regions thereof is aligned with the optical axis. FIGS. 26 and 27 show merely one example of such arrangements.

Finally, conditions for the magnitude of the phase modulation by the diffraction grating 6 and the magnitude of the phase modulation by the diffraction grating 5 to be equal to each other in terms of absolute values thereof are determined.

Based on optical parameters (the thickness t_{Oc}, the protruding regions, the thickness t_{Ot} of the depressed regions, and the refractive index n_{O}) of the diffraction grating 5, a phase advance dL_{Odt} experienced by the on-axis ray Rₓ that passes through one of the depressed regions of the diffraction grating 5 relative to the ray R_{A} that travels along the optical axis (that passes through one of the protruding regions) is expressed by Expression (13) below.

ΔL_{Odt}=n_{O}·t_{Oc}−(n_{O}·t_{Ot}+(t_{Oc}−t_{Ot}))=(n_{O}−1)(t_{Oc}−t_{Ot}) (13)

Similarly, based on optical parameters (the thickness t_{Ic} of the protruding regions, the thickness t_{It} of the depressed regions, and the refractive index n_{I}) of the diffraction grating 6, a phase advance di_{Idt} experienced by the on-axis ray R_{X} that passes through one of the protruding regions of the diffraction grating 6 relative to the ray R_{A} that travels along the optical axis (that passes through one of the depressed regions) is expressed by Expression (14) below.

ΔL_{Idt}=(n_{I}·t_{It}+(t_{Ic}−t_{It}))−n_{I}·t_{Ic}=−(n_{I}−1)(t_{Ic}−t_{It}) (14)

In this case, because the value of nL_{Odt} is positive and the value of Δi_{Idt} is negative, the condition for the absolute values of the two to be equal to each other is expressed by Expression (15) below.

ΔL_{Odt}+ΔL_{Idt}=(n_{O}−1)(t_{Oc}−t_{Ot})−(n_{I}−1)(t_{Ic}−t_{It})=0 (15)

Note that, although the above descriptions are based on the on-axis ray, so long as the above-described condition is satisfied, the diffraction grating 5 performs the function of disturbing a wavefront, and the diffraction grating 6 also performs the function of restoring a wavefront for an off-axis ray also.

In addition, although the cross-sectional shape of the diffraction gratings 5 and 6 is assumed to be trapezoidal in the above descriptions, it is needless to say that similar functions can also be performed with other shapes.

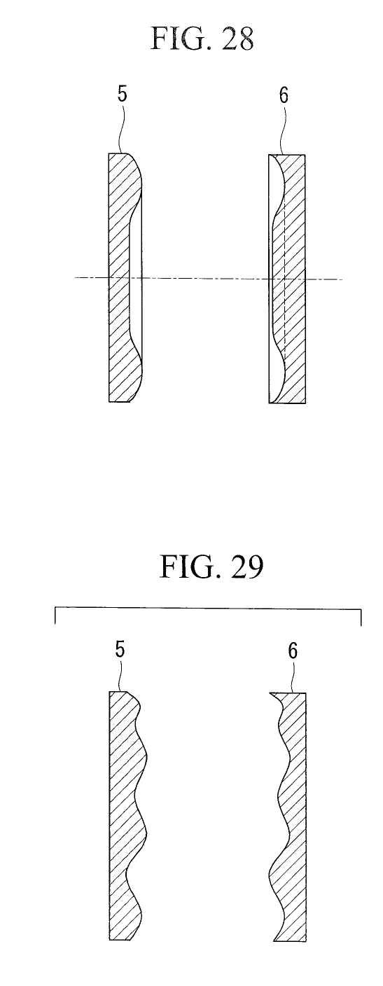

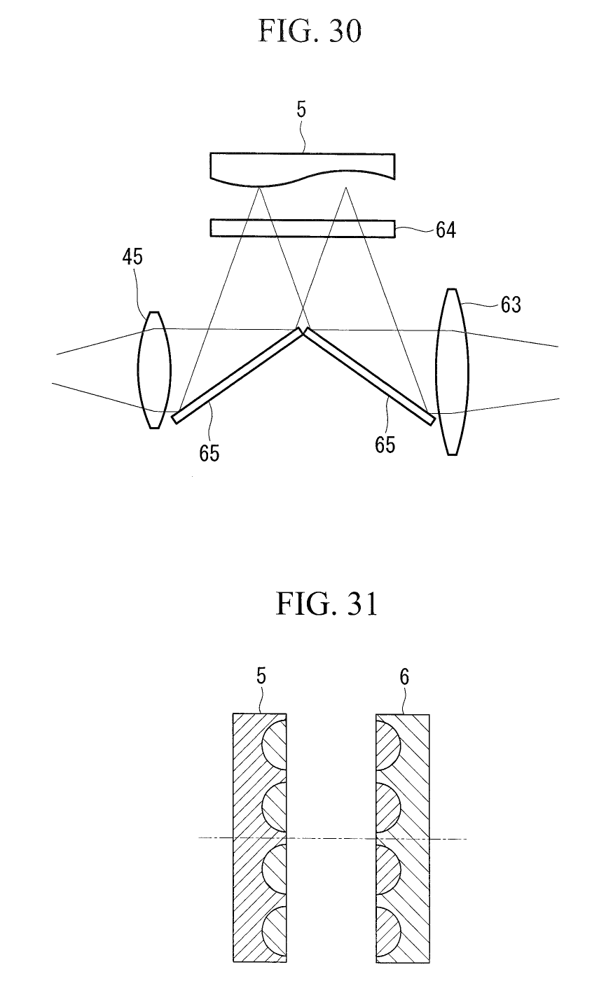

Furthermore, as the phase modulators 5 and 6, spherical aberration devices shown in FIG. 28, irregular-shaped devices shown in FIG. 29, reflecting-type wavefront modulating devices in a combination with the transmitting Expr spatial light modulator 64 shown in FIG. 30, or gradient-index devices shown in FIG. 31 may be employed.

Additionally, as the phase modulators 5 and 6, a fly-eye lens or a microlens array, in which numerous minute lenses are arrayed, or a microprism array, in which numerous minute prisms are arrayed, may be employed.

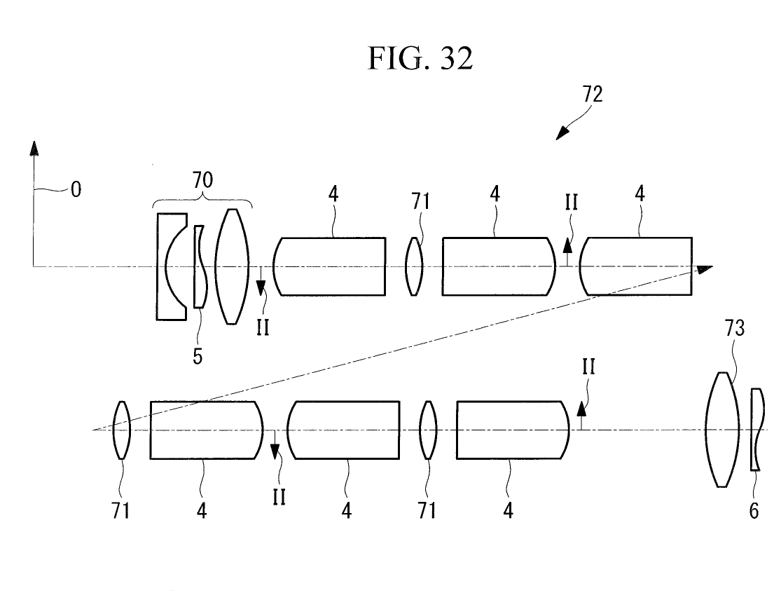

In addition, in the case in which the image-forming optical systems 1 according to the above-described embodiments are applied to endoscopes, as shown in FIG. 32, a phase disturbing device 5 needs to be disposed inside the objective lens (image-forming lens) 70, and a phase restoring device 6 needs to be disposed in the vicinity of an ocular lens 73 that is positioned on the opposite side from the objective lens 70 with a relay optical system 72 that includes a plurality of field lenses 4 and focusing lenses 71 placed therebetween. By doing so, it is possible to make intermediate images formed in the vicinity of the surfaces of the field lenses 4 unsharp, and it is possible to make the final image formed by the ocular lens 73 sharp.

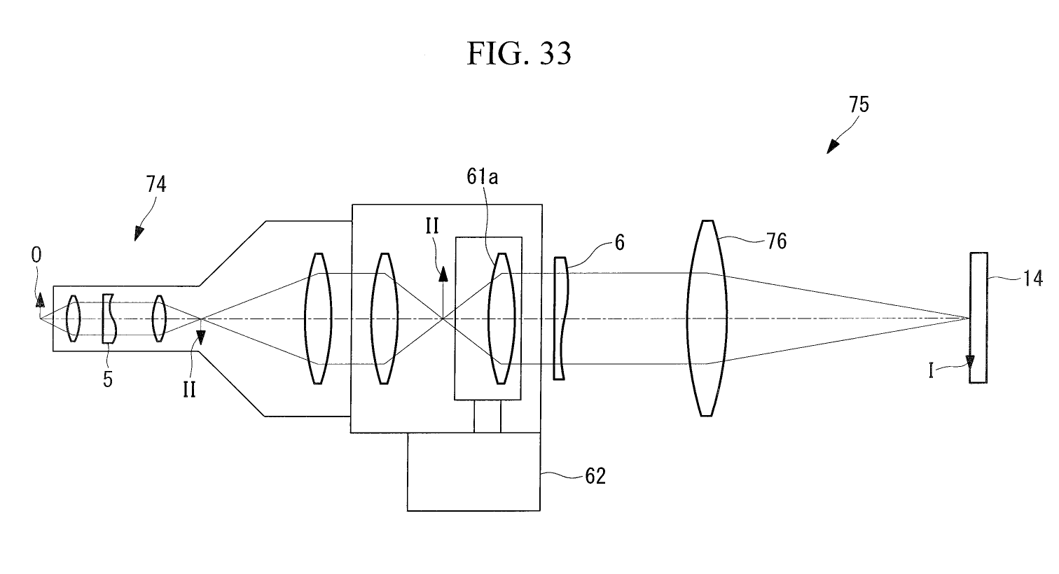

In addition, as shown in FIG. 33, the wavefront disturbing device 5 may be provided in an endoscope-type small-diameter objective lens 74 including an inner focusing function, in which a lens 61a is driven by an actuator 62, and the wavefront restoring device 6 may be disposed in the vicinity of the pupil position of a tube lens (image-forming lens) 76 provided in a microscope main unit 75. In this way, although the actuator itself may be a publically-known lens-driving means (for example, a piezoelectric element), in terms of movement of intermediate images on the Z-axis, it is important that, from a viewpoint similar to that of the above-described embodiments, an arrangement that allows execution of spatial modulation of the intermediate images is employed.

The embodiments that have been discussed above relate to cases in which, from the viewpoint of movement of the intermediate images on the Z-axis, unsharpening of the intermediate images by means of a spatial modulation is applied to an image-forming optical system of an observation apparatus. From the viewpoint of movement of intermediate images on the XY-axes (or XY-plane), which is another viewpoint, similarly, it is possible to apply the process to an observation apparatus.

The phase modulators for the image-forming optical system of the present invention, discussed above, may take forms described below, and a person skilled in the art can consider appropriate embodiments on the basis of the scope indicated below. Because the forms described below provide phase modulators for an image-forming optical system that is characterized in that the configuration thereof is such that spatial disturbance and disturbance cancellation in the above-described (set of) phase modulators are adjusted or increased, it can be concluded that the unique operational effects of the phase modulators of the present invention can be advanced or made advantageous in practical use.

(1) Concave-Convex Periodically-Structured Phase Modulator

For example, an image-forming optical system may be configured so that, with regard to the first phase modulator for unsharpening images and the second phase modulator for restoring the images, a modulation distribution of a region in which the phase thereof leads with respect to an average phase modulation distribution and a modulation distribution of a region in which the phase thereof lags with respect to that average have symmetrical shapes with respect to the above-described average; and so that, with the set of the above-described phase-lead region and the above-described phase-lag region, multiple sets are formed having periodicity. In this way, by employing two phase modulators having the same shape and by appropriately disposing them in an optical system, it is possible to perform complementary phase modulations, that is, it is possible to sharpen a final image by means of the second phase modulator by unsharpening intermediate images by means of the first phase modulator; and therefore, it is possible to solve the problem of intermediate images. Here, because it is not necessary to prepare two different types of phase modulators in order to achieve complementarity and it suffices to use one type of phase modulator, device manufacturing is facilitated, which also makes it possible to reduce costs.

In addition, the phase modulations by means of the first and second phase modulators may be performed by means of surface shapes of an optical medium (for example, by employing a shape in which shapes formed of concave portions and convex portions are periodically arranged). By doing so, it is possible to manufacture required phase modulators by using a manufacturing method similar to that for general phase filters. In addition, the phase modulations by means of the first and second phase modulators may be performed by means of interface shapes of a plurality of optical media. By doing so, with the same optical-medium-shape precision, it is possible to perform phase modulation with a greater precision. Alternatively, with the same phase-modulation precision, it is possible to manufacture a phase modulator at a lower optical-medium-shape precision, that is, a lower cost. In addition, the first and second phase modulators may have one-dimensional phase distribution characteristics. By doing so, it is possible to effectively unsharpen intermediate images. In addition, the first and second phase modulators may have two-dimensional phase distribution characteristics. By doing so, it is possible to effectively unsharpen intermediate images.

(2) Liquid-Crystal Phase Modulator

In addition, an image-forming optical system may be configured so that the first and second phase modulators have liquid crystals that are flanked by a plurality of substrates. By doing so, by utilizing the birefringence of the liquid crystals, it is possible to unsharpen an intermediate image by separating one light-focusing point in the intermediate image into a plurality of light-focusing points by means of the first phase modulator, and, in addition, it is possible to sharpen a final image by superimposing the separated light-focusing points into a single light-focusing point by means of the second phase modulator; and therefore, it is possible to solve the problem of intermediate images. In this case, as compared with other birefringent materials, for example, crystals of inorganic materials, such as quartz or the like, liquid crystals that serve as birefringent materials are advantageous in that, because a large variety of liquid crystals exists, the degree of freedom is greater in terms of design, and furthermore, liquid crystals are advantageous in that, because the birefringence properties thereof are high, the effect of unsharpening an intermediate image is high.

In addition, in the case in which surfaces at which the substrates come into contact with the liquid crystals are flat, the liquid crystals that are flanked by flat surfaces exhibit the effect of unsharpening an image by serving as a birefringent prism. In this case, because the surfaces of the substrates that flank the liquid crystals are flat, there is an advantage in that the substrate processing is facilitated. In addition, each of the first and second phase modulators may be formed of a plurality of prisms that are constituted of liquid crystals.

In this case, with every additional prism, the number of light-focusing points in an intermediate image is doubled, thus being separated into more numerous light-focusing points; and therefore, the effect of unsharpening the intermediate image is increased. In addition, each of the first and second phase modulators may include at least one ¼ wavelength plate. In this case, by employing the ¼ wavelength plate, the degree of freedom is increased in terms of the arrangement of the separated light-focusing points in an intermediate image. Employing the ¼ wavelength plate is preferable in that light-focusing points that are separated into, for example, four, eight, or the like by means of a plurality of prisms can be arranged in a straight line.

In addition, configuring an image-forming optical system so that intermediate-image points that are separated by the above-described birefringence are two-dimensionally arranged is preferable in that it is possible to effectively unsharpen an intermediate image.

In addition, the phase modulators may be configured so that the surfaces at which the substrates come into contact with the liquid crystals take irregular shapes (concave surfaces, convex surfaces, surfaces having both concavity and convexity, or non-flat surfaces). With such a configuration, it is possible to increase the effect of unsharpening an intermediate image that irregular shapes (cylindrical surfaces, toric surfaces, lenticular surfaces, microlens-array shapes, randomly-shaped surfaces, or the like) inherently possess. In addition, the irregular shapes of the substrates in the first and second phase modulators may be designed so as to be complementary with each other, and so that the directions in which the liquid crystals are oriented in the first and second phase modulators are parallel to each other. With such a design, it is possible to impart complementarity to phase modulations applied by the two phase modulators; in other words, it is possible to perform restoration of a final image (final image). Furthermore, the first and second phase modulators may be configured so that the irregular shapes of the substrates of the first and second phase modulators are the same, so that the refractive index of glass materials constituting the substrates is equal to the average of two principal refractive indexes of the liquid crystals, and so that the directions in which the liquid crystals are oriented in the first and second phase modulators are orthogonal to each other. By doing so also, it is possible to impart complementarity to the phase modulations applied by the two phase modulators; in other words, it is possible to perform restoration of a final image.

(3) Heterogeneous-Multiple-Media Phase Modulator

The above-described image-forming optical systems may be configured so that surface shapes at boundaries of multiple types of optical media serve as phase modulation means. In this case, the allowance for errors in dimensions thereof is increased as compared with an ordinary phase modulator (in which shapes at aninterface with air serve as phase modulation means). By doing so, manufacturing thereof is facilitated, and, even if the levels of errors in dimensions are the same, it is possible to perform phase modulations with greater precision. In this case, the first and second phase modulators may be configured so that both phase modulators are in contact with a plurality of different types of optical media having different refractive indexes from each other. By configuring both of the phase modulators as multiple-medium types, it is possible to further increase the ease of manufacturing and to enhance the precision of phase modulation.

In addition, the first and second phase modulators may be configured so that a first optical-medium portion, which constitutes the first phase modulator, and a second optical-medium portion, which constitutes the second phase modulator, have the same shapes, so that a third optical medium that is brought into contact with the first optical medium has the same refractive index as that of the second optical medium, and so that a fourth optical medium that is brought into contact with the second optical medium has the same refractive index as that of the first optical medium. By doing so, it is possible to apply complementary phase-modulation characteristics by employing a set of optical media having a common refractive index in each of the first and second phase modulators and by switching only the relationships with respect to the shapes thereof. In this case, additionally, because the interface shapes between the optical media in the respective phase modulators are the same, when disposing the two phase modulators in an optical system, including the viewpoint of three-dimensional shapes of the interfaces, it is possible to dispose the phase modulators in an optically conjugate manner, and thus, the effect of the second phase modulator that cancels out a wavefront disturbance (sharpening) is more accurately exhibited. Furthermore, if not just the refractive indexes but the optical media themselves are common, even if there is variability in the refractive indexes of the optical media depending on the manufacturing lot or the like or even if there are influences of environment or changes that occur over time, because phase-modulation displacements caused by such factors are naturally canceled out between the two phase modulators, the sharpening effect of the second phase modulator is more accurately exhibited.

In addition, the image-forming optical system may be configured so that a first optical-medium portion, which constitutes the first phase modulator, and a second optical-medium portion, which constitutes the second phase modulator, have the same shapes and the same refractive indexes, and so that, with regard to a refractive-index difference Δₙ₁ between the first optical medium and the third optical medium, which is brought into contact with the first optical medium, and a refractive-index difference Δn2 between the second optical medium and the fourth optical medium, which is brought into contact with the second optical medium, the absolute values of Δn1 and Δn2 are equal to each other and the signs thereof are opposite each other. By doing so, complementary phase-modulation characteristics are applied by employing, in a common manner, phase modulators having the same shapes and refractive indexes as one of the plurality of optical-medium portions that constitute each of the first and second phase modulators; with respect to the common refractive indexes, by employing, in one of the phase modulators, a set of optical media having a greater refractive indexes and by employing, in the other phase modulator, a set of optical media having, in contrast, lower refractive indexes; and by setting absolute values of refractive-index differences of the respective sets to be equal to each other. In this case, as with the cases described above, because the interface shapes of the respective phase modulators are the same, when disposing the two phase modulators in a conjugate manner, the second phase modulator more accurately performs sharpening. Furthermore, in the above-described common portions, if not just the shapes and refractive indexes but the optical elements themselves are common, it is possible to reduce the costs of phase modulators that have complex shapes and that are highly difficult to manufacture. In addition, for example, in the case of manufacturing these optical elements by means of molding by using metal molds or the like, even if unexpected errors occur in the shapes thereof due to detects in the metal molds, because those errors in the shapes exist in common among the individual optical elements, errors in phase modulation caused by the error portions of the first phase modulator are naturally cancelled out by the error portions that also exist, in a common manner, in the second phase modulator, which is disposed in a conjugate manner with respect to the first phase modulator. In other words, the effect of the second phase modulator that cancels out a wavefront disturbance (sharpening) is more accurately exhibited.

(4) Birefringent Phase Modulator

In addition, the above-described image-forming optical systems may be configured so that the first and second phase modulators are prisms constituted of birefringent media. When such a configuration is employed, by appropriately disposing, in an optical system, a set of birefringent prisms that are formed of the same materials and that have the same shapes, it is possible to unsharpen an intermediate image by separating one light-focusing point in the intermediate image into a plurality of light-focusing points by means of a first prism, that is, the first phase modulator, and it is possible to sharpen a final image by superimposing the separated light-focusing points into a single light-focusing point again by means of a second prism, that is, the second phase modulator; and therefore, it is possible to solve the problems of intermediate images. Here, because it is possible to configure the phase modulators only by combining components in which materials thereof are polished into flat surfaces, for example, complex surface shapes such as microlens array or lenticular shapes are not necessary, and thus, device manufacturing is facilitated, which makes it possible to reduce costs.

In addition, each of the first and second phase modulators may be formed of a plurality of prisms that are constituted of birefringence media. In this case, with every additional prism, because the number of light-focusing points in an intermediate image are doubled, thus being separated into more numerous light-focusing points, the effect of unsharpening the intermediate image is increased. In addition, each of the first and second phase modulators may include at least one ¼ wavelength plate. By employing the ¼ wavelength plate, the degree of freedom is increased in terms of the arrangement of the separated light-focusing points in an intermediate image, and thus, light-focusing points that are separated into, for example, four, eight, or the like by means of the plurality of prisms can be arranged in a straight line. In addition, the first and second phase modulators may be configured so that intermediate-image points separated due to birefringence are two-dimensionally arranged, and, by doing so, it is possible to effectively unsharpen an intermediate image.

As a result, the above-described embodiments lead to the following aspects.

An aspect of the present invention is an image-forming optical system including a plurality of image-forming lenses that form a final image and at least one intermediate image; a first phase modulator that is disposed closer to an object than any one of the intermediate images formed by the image-forming lenses and that applies a spatial disturbance to a wavefront of light coming from the object; a second phase modulator that is disposed at a position that sandwiches at least one of the intermediate images with the first phase modulator and that cancels out the spatial disturbance applied to the wavefront of the light coming from the object by the first phase modulator, and an adjusting means for adjusting an optical magnification in an image-forming relationship between the first and second phase modulators.

In this specification, two concepts about the form of an image, namely, “sharp image” and “unsharp image” (or “unfocused image”) are used.

First, a “sharp image” is an image that is generated via an image-forming lens in a state in which a spatial disturbance is not applied to the wavefront of the light emitted from the object or in a state in which a disturbance that is applied once is cancelled out and eliminated, and refers to an image having a spatial frequency band determined by the wavelength of the light and the numerical aperture of the image-forming lens, a spatial frequency band based thereon, or a desired spatial frequency band in accordance with the purpose.

Next, an “unsharp image” (or an “unfocused image”) is an image that is generated via an image-forming lens in a state in which a spatial disturbance is applied to the wavefront of the light emitted from the object, and refers to an image having properties such that a final image is formed so as to include practically no blemishes, foreign objects, defects or the like that exist on a surface of or inside an optical element disposed in the vicinity of that image.

Furthermore, particularly in the present invention, it is preferable that a means for adjusting an optical magnification in an image-forming relationship between the first and second phase-modulators be provided.

After passing through the first phase-modulator, the light emitted from the object forms an image of the first phase-modulator via a relay optical system, and this image is projected to the second phase-modulator. At this time, if the relay optical system is manufactured without any manufacturing error, with the above-described light, the spatial disturbance that has been applied to the wavefront thereof by the first phase-modulator is completely cancelled out by passing through the second phase-modulator, and thus, in the final image, it is possible to form a sharp image. However, if there are manufacturing errors in the relay optical system, the size of the image that is projected to the second phase-modulator may be too large or too small due to changes in the projection magnification. When such variability in the magnification exists, it is not possible to cancel out, by means of the second phase-modulator, the spatial disturbance, applied by the first phase-modulator, in the wavefront of the light coming from the object, and thus, in the final image, it is not possible to form a sharp image. Such a unique problem can be solved by providing various adjusting part for finely adjusting the image-forming magnification between the phase-modulators. With such an image-forming-magnification adjusting part, an advantageous effect unique to the present invention is afforded in that the variability in the magnification due to the manufacturing errors in the lenses is absorbed by adjusting, by means of the above-described adjusting part, the optical magnification in the image-forming relationship between the first and second phase-modulators, and thus, it is possible to completely cancel out the mutual effects of the two phase-modulators.

An “unsharp image” (or an “unfocused image”) formed in this way differs from a simple out-of-focus image in that, including an image at a position at which the image was originally supposed to be formed (that is, a position at which the image would be formed if the spatial disturbance were not applied to the wavefront), an unsharp image does not have a clear peak of the image contrast over a large area in the optical-axis direction and that the spatial frequency band thereof is always narrower as compared with the spatial frequency band of a “sharp image”.

In the following, “sharp image” and “unsharp image” (or “unfocused image”) in this specification are based on the above-described concepts, and moving an intermediate image on the Z-axis means, in the present invention, that the intermediate image is moved in a blurry state. In addition, Z-axis scanning is not limited to moving light in the Z-axis, and, as described later, XY-light movements may be performed together therewith.

With this aspect, the light that has entered the image-forming lenses from the object side is focused by the image-forming lenses, thus forming the final image. In this case, by passing through the first phase modulator, which is disposed closer to the object than one of the intermediate images, a spatial disturbance is applied to the wavefront of the light, and thus, the intermediate image that is formed is made unclear. In addition, the light that has formed the intermediate image passes through the second phase modulator, and thus, the spatial disturbance applied to the wavefront thereof by the first phase modulator is cancelled out. By doing so, in the final-image formation, which is performed after the light passes through the second phase modulator, it is possible to acquire a sharp image.

Specifically, by making the intermediate image unclear, even if some optical element is disposed at the intermediate-image position, and blemishes, foreign objects, defects, or the like exist on the surface of or inside this optical element, it is possible to prevent the occurrence of a problem whereby the blemishes, foreign objects, defects, or the like are superimposed on the intermediate image and are included as part of the finally formed final image In addition, in the case in which the system is applied to a microscope optical system, even if the intermediate images that are moved on the Z-axis due to focusing or the like overlap with lenses that are positioned in front of or behind the images, noise images such as images of blemishes and foreign objects on the surfaces of the lenses or defects or the like in the lenses that unexpectedly appear in the final image are not generated.

In the above-described aspect, the first phase-modulating element and the second phase-modulating element may be disposed at optically conjugate positions.

In the above-described aspect, the first phase modulator and the second phase modulator may be disposed in a vicinity of pupil positions of the image-forming lenses.

By doing so, the sizes of the first phase modulator and the second phase modulator can be reduced by disposing them in the vicinity of the pupil positions where beams do not change.

In addition, the above-described aspect may be provided with an optical-path-length varying part that can vary an optical-path length between the two image-forming lenses disposed at positions that sandwich any one of the intermediate images.

By doing so, by changing the optical-path length between the two image-forming lenses by actuating the optical-path-length varying part, it is possible to easily change the image-forming position of the final image in the optical-axis direction.

In addition, in the above-described aspect, the optical-path-length varying part may be provided with a flat mirror that is disposed perpendicularly to an optical axis and that reflects light that forms the intermediate images so as to fold back the light; an actuator that moves the flat mirror in an optical-axis direction; and a beam splitter that splits the light reflected by the flat mirror into light in two directions.

By doing so, the light coming from the object side, which is collected by the object-side image-forming lens, is reflected by the flat mirror to be folded back and is subsequently split by the beam splitter, thus being made to enter the image-side image-forming lens. In this case, by moving the flat mirror in the optical-axis direction by actuating the actuator, it is possible to easily change the optical-path length between the two image-forming lenses, and thus, it is possible to easily change the image-forming position of the final image in the optical-axis direction.

In addition, the above-described aspect may be provided with a variable spatial phase modulator that is disposed in a vicinity of a pupil position of any one of the image-forming lenses, and that changes a position of the final image in the optical-axis direction by changing a spatial phase modulation to be applied to the wavefront of the light.

By doing so, it is possible to apply a spatial phase modulation to the wavefront of the light such that the final-image position is changed in the optical-axis direction by means of the variable spatial phase modulator, and it is possible to easily change the image-forming position of the final image in the optical-axis direction by adjusting the phase modulation to be applied.

In addition, in the above-described aspect, a function of at least one of the first phase modulator and the second phase modulator may be performed by the variable spatial phase modulator.

By doing so, it is possible to make the variable spatial phase modulator bear the function of applying a spatial phase modulation that changes the final-image position in the optical-axis direction and a phase modulation that makes the intermediate image unclear or a phase modulation that cancels out the unclearness of the intermediate image. By doing so, it is possible to form an image-forming optical system with a simple configuration by reducing the number of components.

In addition, in the above-described aspect, the first phase modulator and the second phase modulator may apply, to a wavefront of a beam, phase modulations that change in a one-dimensional direction perpendicular to an optical axis.

By doing so, it is possible to make the intermediate image unclear by applying, to the wavefront of the light, the phase modulation that changes in a one-dimensional direction perpendicular to the optical axis by using the first phase modulator, and, even if some optical element is disposed at the intermediate-image position and blemishes, foreign objects, defects, or the like exist on the surface of or inside this optical element, it is possible to prevent the occurrence of a problem whereby the blemishes, foreign objects, defects, or the like are superimposed on the intermediate image and are included as part of the finally formed final image. In addition, it is possible to form a sharp final image without blurriness by applying, to the wavefront of the light, the phase modulation that cancels out the phase modulation that has changed in the one-dimensional direction by using the second phase modulator.

In addition, in the above-described aspect, the first phase modulator and the second phase modulator may apply, to a wavefront of a beam, phase modulations that change in two-dimensional directions perpendicular to an optical axis.

By doing so, it is possible to more reliably make the intermediate image unclear by applying, to the wavefront of the light, the phase modulation that changes in the two-dimensional directions perpendicular to the optical axis by using the first phase modulator. In addition, it is possible to form a sharper final image by applying, to the wavefront of the light, the phase modulation that cancels out the phase modulation that has changed in the two-dimensional directions by using the second phase modulator.

In addition, in the above-described aspect, the first phase modulator and the second phase modulator may be transmitting-type devices that apply phase modulations to a wavefront of light when allowing the light to pass therethrough.

In addition, in the above-described aspect, the first phase modulator and the second phase modulator may be reflecting-type devices that apply phase modulations to a wavefront of light when reflecting the light.

In addition, in the above-described aspect, the first phase modulator and the second phase modulator may have complementary shapes.

By doing so, it is possible to employ simple configurations in the first phase modulator that applies, to the wavefront, the spatial disturbance that makes the intermediate image unclear and the second phase modulator that applies the phase modulation that cancels out the spatial disturbance applied to the wavefront.

In addition, in the above-described aspect, the first phase modulator and the second phase modulator may apply phase modulations to a wavefront by using a refractive-index distribution of a transparent material.

By doing so, it is possible to generate a wavefront disturbance in accordance with the refractive-index distribution when the light passes through the first phase modulator, and it is possible to apply, to the wavefront of the light, the phase modulation that cancels out the wavefront disturbance by using the refractive-index distribution when the light passes through the second phase modulator.

In addition, another aspect of the present invention is an illumination apparatus including: any one of the above-described image-forming optical systems and a light source that is disposed on an object side of the image-forming optical system and that generates illumination light to be made to enter the image-forming optical system.

With this aspect, by making the illumination light emitted from the light source disposed on the object side enter the image-forming optical system, the object to be illuminated, disposed on the final-image side, can be illuminated by the illumination light. In this case, because the intermediate image formed by the image-forming optical system is made unclear by the first phase modulator, even if some optical element is disposed at the intermediate-image position and blemishes, foreign objects, defects, or the like exist on the surface of or inside this optical element, it is possible to prevent the occurrence of a problem whereby the blemishes, foreign objects, defects, or the like are superimposed on the intermediate image and are included as part of the finally formed final image.

In addition, another aspect of the present invention is a microscope apparatus including any one of the above-described image-forming optical systems and a photo-detector that is disposed on a final-image side of the image-forming optical system and that detects light emitted from an observation subject.

With this aspect, with the photo-detector, it is possible to detect a sharp final image that is formed by preventing images of blemishes, foreign objects, defects, or the like on the surface of or inside the optical element from being superimposed on the intermediate image by using the image-forming optical system.

In the above-described aspect, the photo-detector may be disposed at a final-image position in the image-forming optical system and is an image-acquisition device that captures the final image.

By doing so, it is possible to perform high-precision observation by capturing a sharp final image by using the image-acquisition device disposed at the final-image position in the image-forming optical system.

In addition, another aspect of the present invention is a microscope apparatus including any one of the above-described image-forming optical systems; a light source that is disposed on an object side of the image-forming optical system and that generates illumination light to be made to enter the image-forming optical system; and a photo-detector that is disposed on a final-image side of the image-forming optical system and that detects light emitted from an observation subject.

With this aspect, the light coming from the light source is focused by the image-forming optical system and is radiated onto the observation subject, and the light generated at the observation subject is detected by the photo-detector that is disposed on the final-image side. By doing so, it is possible to detect a sharp final image with the photo-detector, which is formed by preventing images of blemishes, foreign objects, defects, or the like on the surface of or inside the intermediate optical element from being superimposed on the intermediate image.

The above-described aspect may be provided with a Nipkow-disk-type confocal optical system that is disposed between the light source, and the photo-detector and image-forming optical system.

By doing so, it is possible to acquire a sharp image of the observation subject at high speed by scanning the observation subject with multiple spots of light.

In addition, in the above-described aspect, the light source may be a laser light source, and the photo-detector may be provided with a confocal pinhole and a photoelectric conversion device.

By doing so, it is possible to observe the observation subject by using a sharp confocal image in which images of blemishes, foreign objects, defects, or the like at the intermediate-image position do not appear.

In addition, another aspect of the present invention is a microscope apparatus including the above-described illumination apparatus and a photo-detector that detects light emitted from an observation subject that is illuminated by the illumination apparatus, wherein the light source is a pulsed laser light source.

By doing so, it is possible to observe the observation subject by using a sharp multi-photon-excitation image in which images of blemishes, foreign objects, defects, or the like at the intermediate-image position do not appear.

The present invention affords an advantage in that it is possible to acquire a sharp final image by preventing images of blemishes, foreign objects, defects, or the like in an optical element from being superimposed on an intermediate image even if the intermediate image is formed at a position coinciding with the optical element, and, furthermore, it is possible to stably acquire a sharp final image even if there are manufacturing errors in a relay optical system.

### REFERENCE SIGNS LIST

I final image
II intermediate image
O object
PP_{O}, PP_{I} pupil position
1, 13, 32, 42 image-forming optical system
2, 3 image-forming lens
5 wavefront disturbing device (first phase modulator)
6 wavefront restoring device (second phase modulator)
10, 30, 40, 50, 60 observation apparatus (microscope apparatus)
11, 31, 41 light source
14, 33 image-acquisition device (photo-detector)
17, 23 phase modulator
20, 36 beam splitter
22 optical-path-length varying part
22a flat mirror
22b actuator
34 Nipkow-disk-type confocal optical system
43 confocal pinhole
44 photo-detector (photoelectric conversion device)
61a lens (optical-path-length varying part)
62 actuator (optical-path-length varying part)
81, 83A, 83B, 87 optical-magnification adjusting portion (adjusting part)

1. An image-forming optical system comprising:
a plurality of image-forming lenses that form a final image and at least one intermediate image;
a first phase modulator that is disposed closer to an object than any one of the intermediate images formed by the image-forming lenses and that applies a spatial disturbance to a wavefront of light coming from the object;
a second phase modulator that is disposed at a position that sandwiches at least one of the intermediate images with the first phase modulator and that cancels out the spatial disturbance applied to the wavefront of the light coming from the object by the first phase modulator; and
an adjusting part that adjusts an optical magnification in an image-forming relationship between the first and second phase-modulating elements.

2. The image-forming optical system according to claim 1, wherein the first phase modulator and the second phase modulator are disposed at optically conjugate positions.

3. The image-forming optical system according to claim 1 or 2, wherein the first phase modulator and the second phase modulator are disposed in a vicinity of pupil positions of the image-forming lenses.

4. The image-forming optical system according to claim 1, further comprising:
an optical-path-length varying part that can vary an optical-path length between the two image-forming lenses disposed at positions that sandwich any one of the intermediate images.

5. The image-forming optical system according to claim 4, wherein the optical-path-length varying part is provided with:
a flat mirror that is disposed perpendicularly to an optical axis and that reflects light that forms the intermediate images so as to fold back the light;
an actuator that moves the flat mirror in an optical-axis direction; and
a beam splitter that splits the light reflected by the flat mirror into light in two directions.

6. The image-forming optical system according to claim 1, further comprising:
a variable spatial phase modulator that is disposed in a vicinity of a pupil position of any one of the image-forming lenses, and that changes a position of the final image in an optical-axis direction by changing a spatial phase modulation to be applied to the wavefront of the light.

7. A phase-modulating element for an image-forming optical system according to claim 6, wherein a function of at least one of the first phase modulator and the second phase modulator is performed by the variable spatial phase modulator.

8. The image-forming optical system according to claim 1, wherein the first phase modulator and the second phase modulator apply, to a wavefront of a beam, phase modulations that change in a one-dimensional direction perpendicular to an optical axis.

9. The image-forming optical system according to claim 1, wherein the first phase modulator and the second phase modulator apply, to a wavefront of a beam, phase modulations that change in two-dimensional directions perpendicular to an optical axis.

10. The image-forming optical system according to claim 1, wherein the first phase modulator and the second phase modulator are transmitting-type devices that apply phase modulations to a wavefront of light when allowing the light to pass therethrough.

11. The image-forming optical system according to claim 1, wherein the first phase modulator and the second phase modulator are reflecting-type devices that apply phase modulations to a wavefront of light when reflecting the light.

12. The image-forming optical system according to claim 1, wherein the first phase modulator and the second phase modulator have complementary shapes.

13. The image-forming optical system according to claim 10, wherein the first phase modulator and the second phase modulator apply phase modulations to a wavefront by using a refractive-index distribution of a transparent material.

14. An illumination apparatus comprising:
an image-forming optical system according to claim 1; and
a light source that is disposed on an object side of the image-forming optical system and that generates illumination light to be made to enter the image-forming optical system.

15. A microscope apparatus comprising:
an image-forming optical system according to claim 1; and
a photo-detector that is disposed on a final-image side of the image-forming optical system and that detects light emitted from an observation subject.

16. A microscope apparatus according to claim 15, wherein the photo-detector is disposed at a final-image position in the image-forming optical system and is an image-acquisition device that captures the final image.

17. A microscope apparatus comprising:
an image-forming optical system according to claim 1;
a light source that is disposed on an object side of the image-forming optical system and that generates illumination light to be made to enter the image-forming optical system; and
a photo-detector that is disposed on a final-image side of the image-forming optical system and that detects light emitted from an observation subject.

18. A microscope apparatus according to claim 17, further comprising:
a Nipkow-disk-type confocal optical system that is disposed between the light source, and the photo-detector and image-forming optical system.

19. A microscope apparatus according to claim 17,
wherein the light source is a laser light source, and
the photo-detector is provided with a confocal pinhole and a photoelectric conversion device.

20. A microscope apparatus comprising:
an illumination apparatus according to claim 14; and
a photo-detector that detects light emitted from an observation subject that is illuminated by the illumination apparatus,
wherein the light source is a pulsed laser light source.
